(19) United States
(12) Patent Application Publication
(10) Pub. No.: US 2018/0088882 A1
(43) Pub. Date: Mar. 29, 2018

(54) INFORMATION PROCESSING APPARATUS, METHOD OF CONTROLLING INFORMATION PROCESSING APPARATUS, AND PROGRAM

(71) Applicant: CANON KABUSHIKI KAISHA, Tokyo (JP)

(72) Inventor: Hiroshi Omura, Kawasaki-shi (JP)

(21) Appl. No.: 15/707,158

(22) Filed: Sep. 18, 2017

(30) Foreign Application Priority Data
Sep. 23, 2016 (JP) 2016-185442

(51) Int. Cl. G06F 3/12

(52) U.S. Cl. CPC G06F 3/1258; G06F 3/1205; G06F 3/1254; G06F 3/1256

(57) ABSTRACT

An information processing apparatus is provided that includes a first reception unit configured to receive selection of a printer driver set including a plurality of printer drivers corresponding to models of a plurality of printing devices; a second reception unit configured to receive selection of a model of a customization target from the printer driver set; a display unit configured to display a screen for customizing printing setting of the printer drivers; and a generation unit configured to generate customization information based on the customized printing setting received via the screen. The display unit is configured to be able to display a first screen for collectively customizing a specific printing setting in a plurality of selected models of the customization target and a second screen for individually customizing a printing setting in one selected model of the customization target.

### BACKGROUND OF THE INVENTION

### Field of the Invention

The present invention relates to an information processing apparatus, a method of controlling the information processing apparatus, and a program, and more particularly, to customization of a printer driver.

### Description of the Related Art

Printer drivers are modules that are installed on client computers and execute processes in response to printing setting requests or printing requests to corresponding printers. To respond to various requests for printing, releases of individually corresponding printer drivers in which initial values of various printing settings are changed are necessary. To respond to the requests speedily, there are customization tools capable of changing setting values of printer drivers before installation. In such kinds of customization tools, for example, initial values of setting values of printer drivers can be changed to different setting values from factory shipment values. Japanese Patent No. 4702948 discloses a tool capable of activating a printing setting user interface using a module that emulates an operation system without installing a printer driver on a client computer and generating a customization setting.

There are driver sets corresponding to a plurality of printer models in one package. If such a driver set is customized using a customization tool, it is necessary to select one model, open a printing setting user interface, and execute a customization setting individually. If it is desired to execute customization for a plurality of printer models, it is necessary to repeat the same customization work for each model, and thus a customization procedure is troublesome.

### SUMMARY OF THE INVENTION

The present invention provides an information processing apparatus capable of applying a customization setting to a plurality of printer models collectively.

According to an aspect of the present invention, an information processing apparatus is provided that includes a first reception unit configured to receive selection of a printer driver set including a plurality of printer drivers corresponding to models of a plurality of printing devices; a second reception unit configured to receive selection of a model of a customization target from the printer driver set; a display unit configured to display a screen for customizing printing setting of the printer drivers; and a generation unit configured to generate customization information based on the customized printing setting received via the screen. The display unit is configured to be able to display a first screen for collectively customizing a specific printing setting in a plurality of selected models of the customization target and a second screen for individually customizing a printing setting in one selected model of the customization target.

According to the present invention, it is possible to provide an information processing apparatus capable of applying a customization setting to a plurality of printer models collectively. Accordingly, a basic setting of which a customization frequency is high can be applied collectively to a plurality of printer models by a simple collective customization setting capable of setting the basic setting collectively.

Further features of the present invention will become apparent from the following description of exemplary embodiments (with reference to the attached drawings).

### BRIEF DESCRIPTION OF THE DRAWINGS

FIG. 1 is a block diagram illustrating a schematic configuration of a system.

FIG. 2 is a block diagram illustrating a hardware configuration of a client computer.

FIGS. 3A to 3C are diagrams illustrating a configuration of modules and files.

FIG. 4 is a schematic diagram illustrating a [basic] tab of a printing setting UI.

FIG. 5 is a schematic diagram illustrating a [device management] tab of the printing setting UI.

FIG. 6 is a flowchart illustrating a customization process in a customization tool.

FIGS. 7A and 7B are flowcharts illustrating a simple collective customization setting process.

FIGS. 8A and 8B are schematic diagrams illustrating a use permission and a model selection dialog.

FIGS. 9A and 9B are schematic diagrams illustrating an OS standard folder designation dialog and an analysis progress situation.

FIGS. 10A and 10B are schematic diagrams illustrating a model selection dialog of a customization target.

FIGS. 11A and 11B are schematic diagrams illustrating a detailed customization setting dialog.

FIGS. 12A and 12B are schematic diagrams illustrating a designation dialog for selecting a customization output destination.

FIGS. 13A and 13B are schematic diagrams illustrating an application candidate model selection dialog of the detailed customization setting.

FIGS. 14A and 14B are schematic diagrams illustrating an IP address setting dialog.

FIG. 15 is a flowchart illustrating a simple collective customization setting and reflecting process.

FIG. 16 is a flowchart illustrating a device option setting process.

FIG. 17 is a flowchart illustrating a detailed customization setting process.

FIG. 18 is a flowchart illustrating a process of applying a detailed customization setting group to other models.

FIGS. 19A and 19B are schematic diagrams illustrating an example of a model type-dependent file for SFP.

FIGS. 20A to 20D are schematic diagrams illustrating management data of display items of the simple collective customization setting.

FIGS. 21A to 21C are schematic diagrams illustrating a customization setting file of SFP.

FIG. 22 is a flowchart illustrating a model display procedure deciding process of the detailed customization setting.

FIG. 23 is a flowchart illustrating a customization setting application process in an installer.

### DESCRIPTION OF THE EMBODIMENTS

Hereinafter, preferred modes for carrying out the present invention will be described with reference to the drawings. A system and a method to be described in the present specification collect, process, and transmit a log of each device. In the following description and the drawings of the present invention, points known to those skilled in the art and unnecessary to understand the description of the present invention are omitted in the present specification.

### First Embodiment

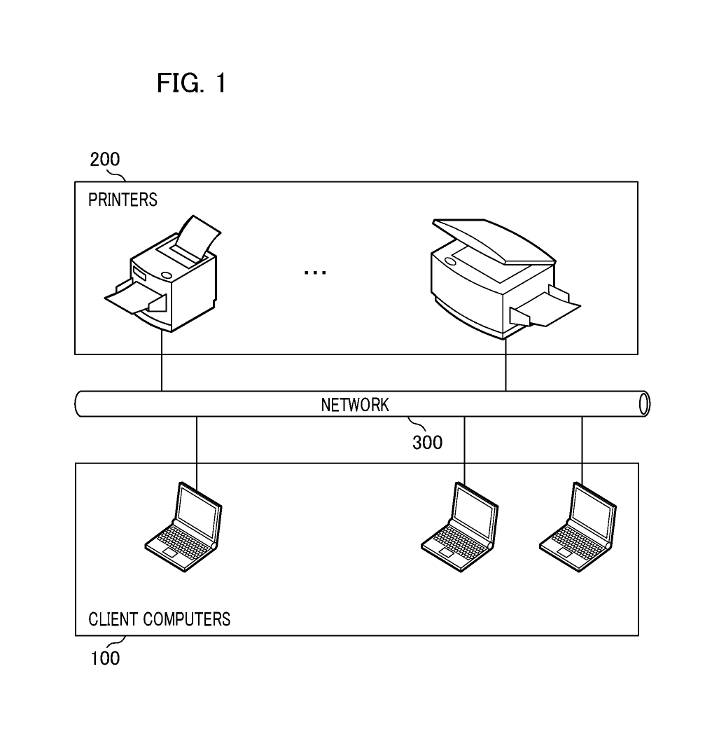

FIG. 1 is a block diagram illustrating a schematic configuration of a system according to the embodiment. The system according to the embodiment includes client computers (information processing apparatuses) 100 and printers 200 capable of receiving printing data with a format of a page description language (hereinafter referred to as a PDL) and executing printing. The client computers 100 and the printers 200 are connected via a network 300 typified by a local area network (LAN) and can execute communication. The printers 200 may be single function printers (SFP) that have only a printing function or may be multi-function printers (MFP) that have a printing function, a scanning function, and a copying function.

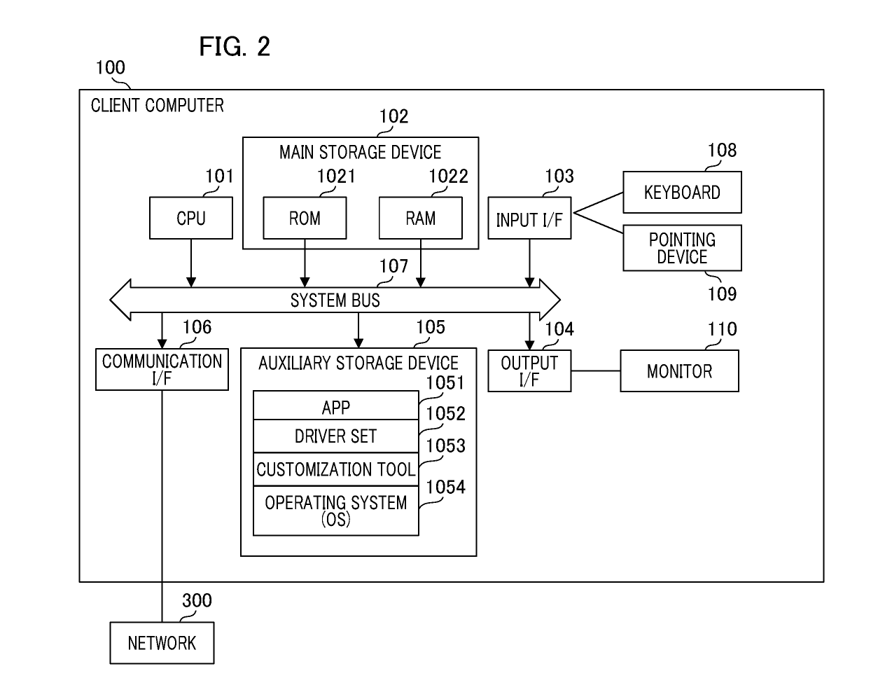

FIG. 2 is a block diagram illustrating a hardware configuration of the client computer 100 according to the embodiment. The CPU 101 controls the entire device in accordance with a program stored in a ROM 1021 or a RAM 1022 of a main storage device 102 or an auxiliary storage device 105. The RAM 1022 is also used as a work area if the CPU 101 executes various processes. The auxiliary storage device 105 stores an application (hereinafter referred to as an app) 1051, a printer driver set 1052, a customization tool 1053 of the driver set 1052, an operating system (OS) 1054, and the like. The application (app) 1051, the driver set (printer driver set) 1052, and the customization tool 1053 can be added to a CD-ROM or a USB memory (neither of which is illustrated) or the auxiliary storage device 105 via the network 300. An input device such as a keyboard 108 or a pointing device 109 typified by a mouse or a touch panel is a device used for a user to give various instructions to the computer via an input I/F 103. An output I/F 104 is an interface through which data is output to the outside and outputs data to an output device such as a monitor (display unit) 110. Here, the printer 200 is connected via the network 300 connected through a communication I/F 106. A bus 107 is a common data system bus and is used to exchange each piece of data between hardware modules configured in the client computer 100.

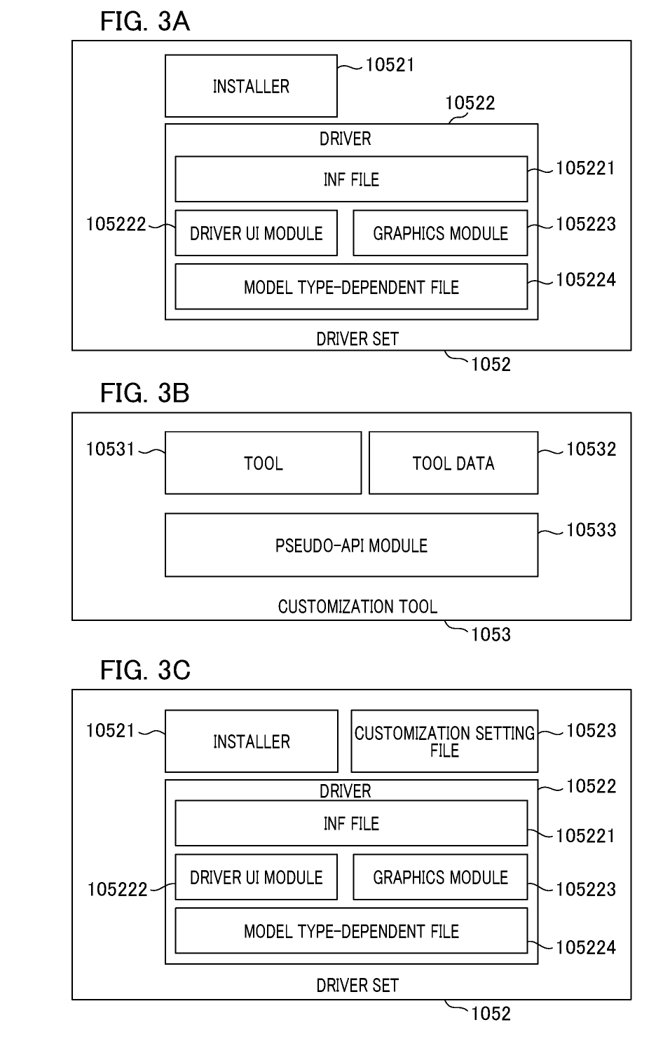

FIG. 3A is a diagram illustrating a configuration of modules and files of the driver set 1052. The driver set 1052 is configured to include an installer 10521 and a driver 10522. The driver 10522 is configured to include an INF file 105221 in which an installation setting is described, a driver UI module 105222, a graphics module 105223, and a model type-dependent file 105224.

The installer 10521 is an execution module that installs the driver 10522 on the OS 1054 based on description of the INF file 105221. The installer 10521 receives a request to install the driver 10522 from a user, and then the OS 1054 loads the installer 10521 from the auxiliary storage device 105 to the RAM 1022 and executes the installer 10521 using the CPU 101. In the embodiment, the driver 10522 corresponds to a plurality of models such as an SFP and an MFP, and information regarding an installation method for the plurality of models is described in the INF file 105221. If the driver 10522 is installed, selection of an installation target model or designation of the printer 200 of an output destination by the user is received and the installation is executed.

As illustrated in FIG. 1, there are the plurality of printers 200 or a plurality of kinds of printer models in the system in some cases. It is necessary to manage a model corresponding to the driver 10522 or an initial value of a printing setting and a printing job for each printer of the output destination. Therefore, the OS 1054 generates an object indicating the printer of the output destination called a printer queue at the time of installation, retains the object in the OS 1054, and manages a configuration module of the driver 10522 or the initial value of the printing setting in association with the printer queue. If the driver 10522 is installed on the OS 1054, a printing setting request or a printing request from the app 1051 can be processed by the module of the driver 10522, and thus printing can be executed by the corresponding printer 200.

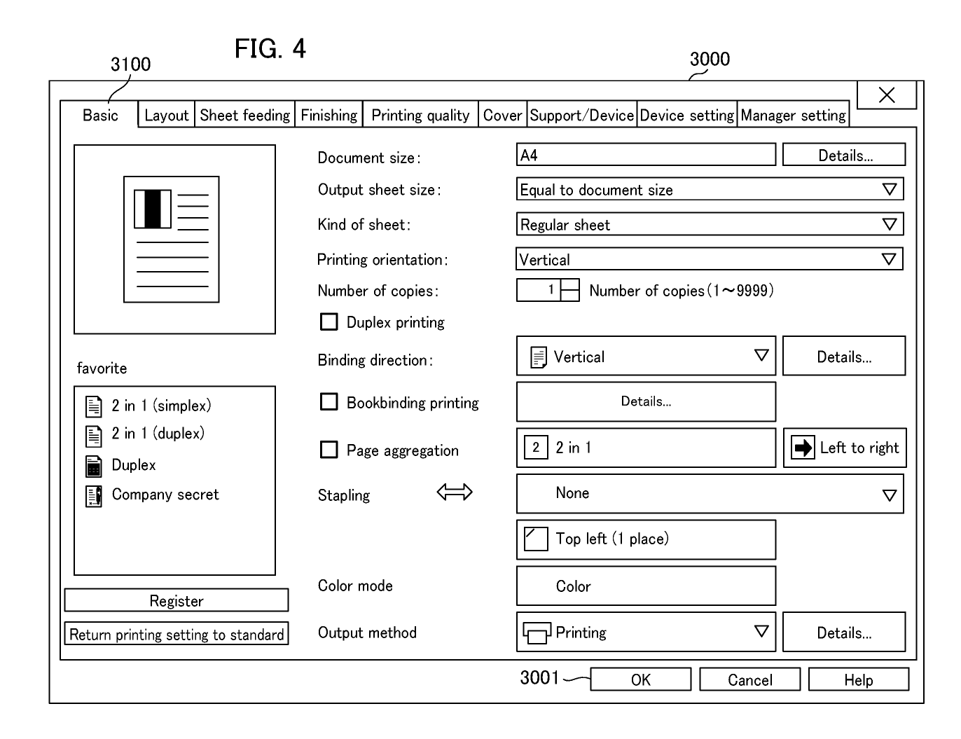

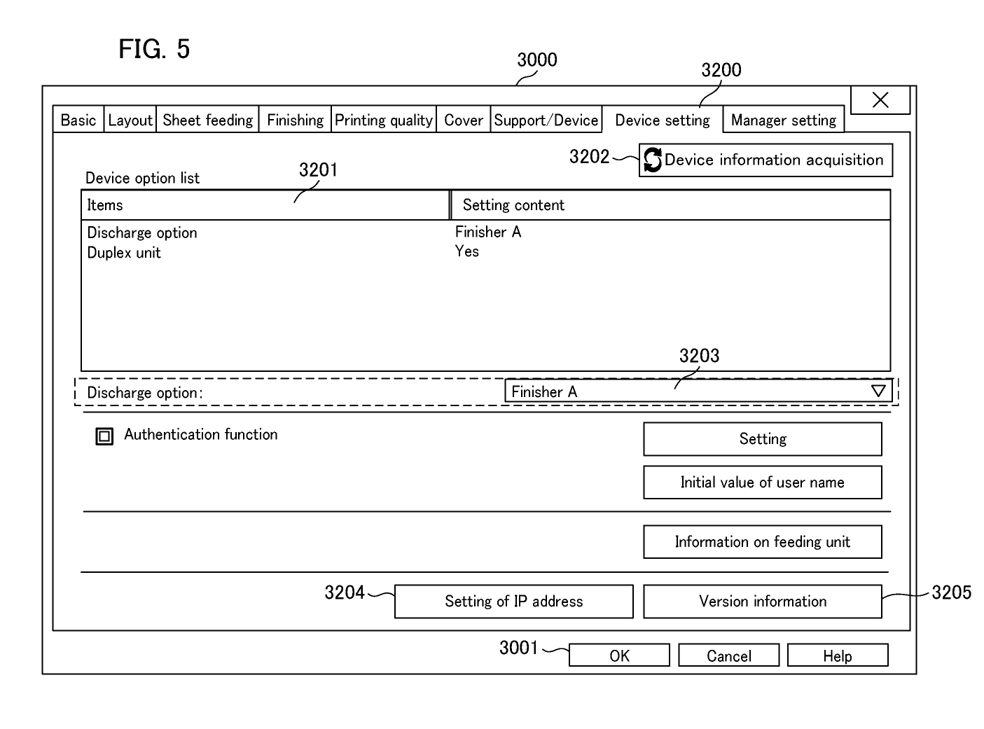

If the printing setting is received from the app 1051 to the printer, the OS 1054 loads the corresponding driver UI module 105222 to the RAM 1022 and causes the CPU 101 to execute the driver UI module 105222. The execution is received and a printing setting UI 3000 is displayed on the monitor 110. An example of a manipulation screen of the printing setting UI 3000 is illustrated in FIGS. 4 and 5. The printing setting UI 3000 is configured to include a plurality of tabs, and a printing setting and a device setting of the output destination are received. The [basic] tab 3100 in FIG. 4 is a tab for printing setting and various UI controls for printing setting such as duplex printing or color printing are disposed. A manipulation to the UI control via the keyboard 108 or the pointing device 109 is received and the driver UI module 105222 generates a current printing setting. A [device management] tab 3200 in FIG. 5 is a tab for managing device options such as a discharge option or a duplex unit.

To respond to various user requests, hardware such as a discharge option or a duplex unit which can be mounted on the printer 200 is embedded as a device option in the printer. For example, since a finisher that is hardware executing stapling on a printing output matter is expensive, the finisher is generally configured in the printer as a separately sold device option in a standard configuration of a printer. To execute the stapling, it is necessary to mount a corresponding finisher on the printer 200. For a user who rarely uses a duplex printing function, a physical duplex mechanism is not included in a low-priced printer and a printer with a standard configuration. There are printers enabled to execute duplex printing only if a duplex unit is mounted as a device option. To deal with such a situation, it is necessary to manage which device option is mounted on the printer 200 of a current output destination.

If communication with the printer 200 is executable, the setting of a current device option can be acquired from the printer 200 via the network 300 by pressing a device information acquisition button 3202. Based on the acquired device information, the driver UI module 105222 reflects setting information regarding a current device option in a device option list 3201. If communication with the printer 200 is not executable, a UI control 3203 can be changed by receiving selection of each item of the device option list 3201 and can also be changed manually. Setting of a device option in a [device] tab 3200 is received and the driver UI module 105222 displays a UI control of the printing setting unusable in the [basic] tab 3100 so that the UI control is in an unselectable state. If various printing settings are set in tabs of the printing setting UI 3000 and subsequently pressing of an OK button 3001 is finally received, the driver UI module 105222 outputs the printing setting and the device setting to the OS 1054 and ends the printing setting request.

Next, an operation of a case in which a printing request from the app 1051 is received will be described. The OS 1054 loads the corresponding driver UI module 105222 to the RAM 1022 and causes the CPU 101 to execute the driver UI module 105222. The execution is received and a PDL for a printing request is generated by the graphics module 105223. The printing setting output in response to the printing setting request is delivered to the graphics module 105223 at the time of the printing request from the app 1051. By changing the printing setting to the PDL by the graphics module 105223, it is possible to change a printing function such as duplex printing or color printing.

The driver 10522 according to the embodiment corresponds to the plurality of models of printers 200. The printing function or the device option supported in each printer 200 differs depending on a model. Support information of the printing function or the device option in each model is gathered in the model type-dependent file 105224. By referring to the model type-dependent file 105224 at the time of execution of the driver UI module 105222, the UI control displayed in the printing setting UI 3000 is changed and only the printing function or the device option supported by the model is displayed.

The customization tool is a tool that customizes the printing setting immediately after the driver set 1052 is installed. FIG. 3B is a diagram illustrating a configuration of modules and files of the customization tool 1053. The customization tool 1053 is configured to include a tool 10531, tool data 10532, and a pseudo-API module 10533 which is an emulator of OS processing. If the driver 10522 is installed in the OS 1054 using the driver set 1052 customized by the customization tool 1053, a printing setting initial value can be changed to a different printing setting initial value from the initial printing setting in the printing setting UI 3000 decided at the time of factory shipment. By opening the printing setting UI 3000 immediately after the customized driver set 1052 is installed, it is possible to confirm a customized state. For example, different initial values from initial values at the time of factory shipment of the driver 10522, such as duplex setting: on, color mode: monochrome and stapling: top left can be applied to the driver 10522 after the installation.

FIG. 3C is a diagram illustrating a configuration of modules and files of the driver set 1052 customized by the customization tool 1053 based on the driver set 1052 of FIG. 3A. A difference between FIGS. 3A and 3C is only a customization setting file 10523. After the customization, the tool 10531 adds the customization setting file 10523 to the driver set 1052. If a driver is installed using the customized driver set 1052, the installer 10521 applies the customized setting to a printer queue in accordance with the customization setting file 10523. Through the application, a different initial printing setting from setting at the time of factory shipment is applied as an initial value of the driver 10522 after the installation.

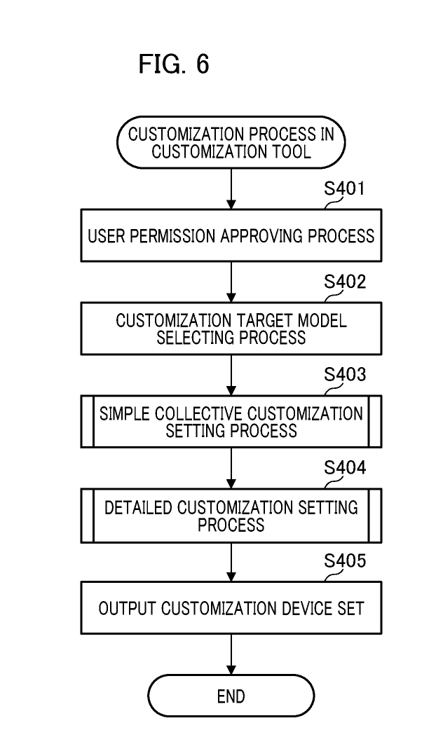

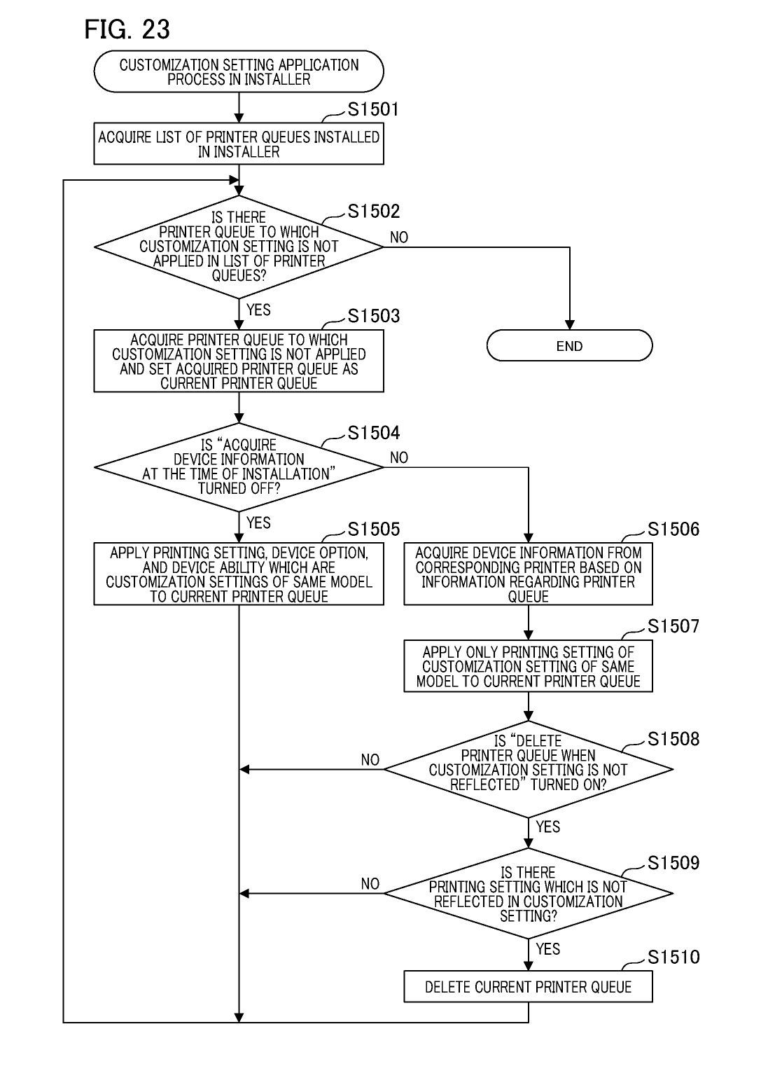

Next, a customization process in the customization tool will be described with reference to the flowchart of FIG. 6. This process starts if an instruction from the user is received and the OS 1054 loads the tool 10531 of the customization tool 1053 from the auxiliary storage device 105 to the RAM 1022 and requests the CPU 101 to execute the process. In flowcharts to be described below, an entity of processes of all of the other flowcharts except for the flowchart of FIG. 23 is the tool 10531 unless otherwise mentioned. The tool 10531 according to the embodiment will be described as an app with a wizard format displaying a plurality of dialogs and setting the display in a procedure necessary for the setting. The invention is not particularly limited to the app with a wizard format, and an app with a single dialog may be used.

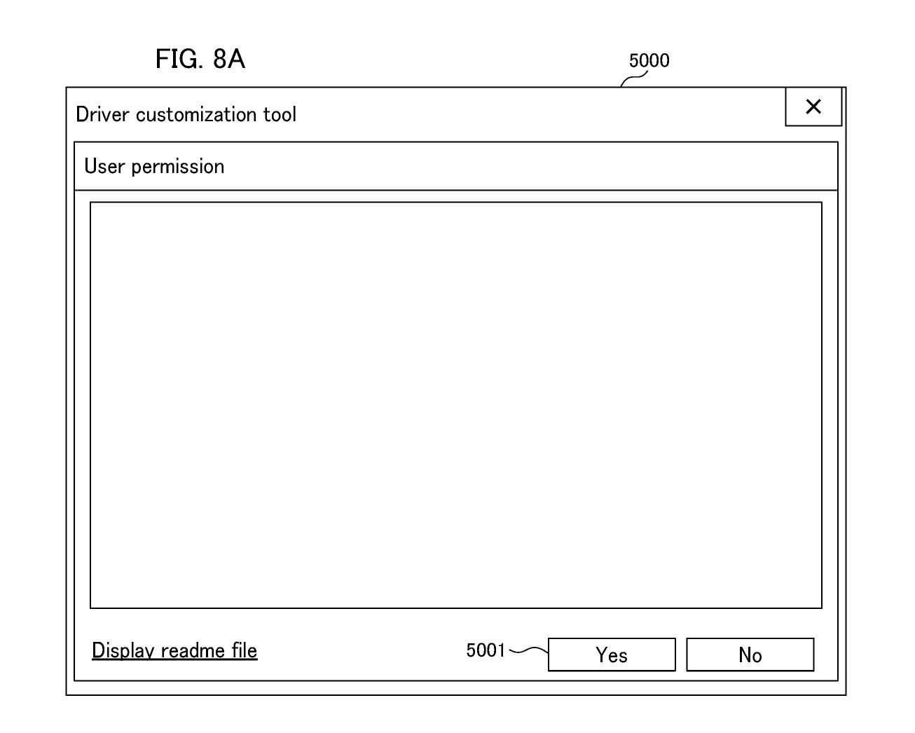

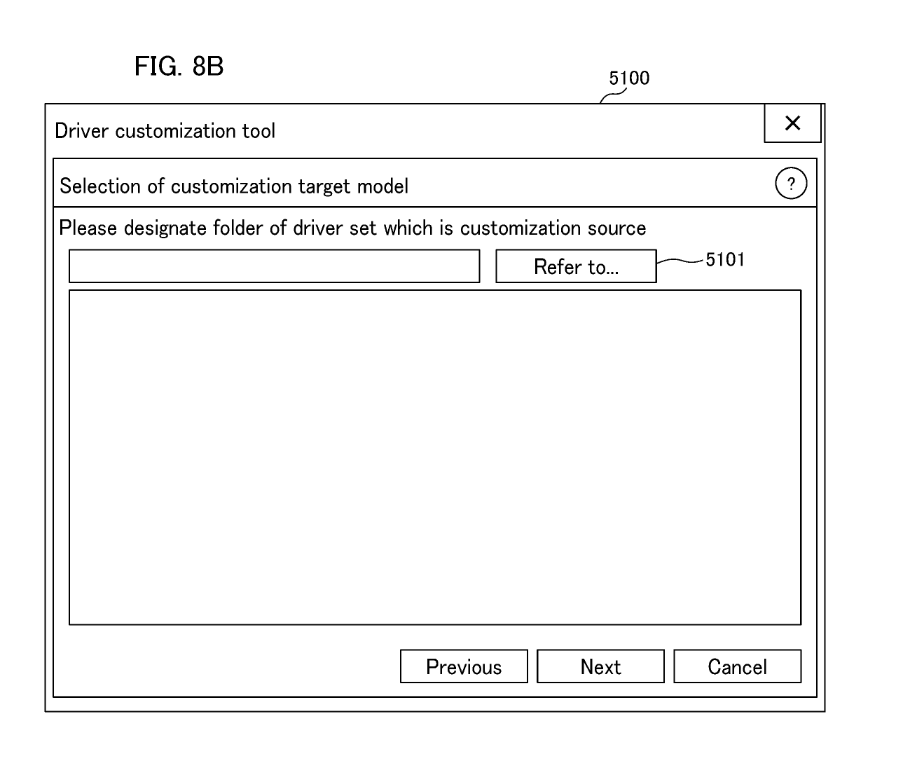

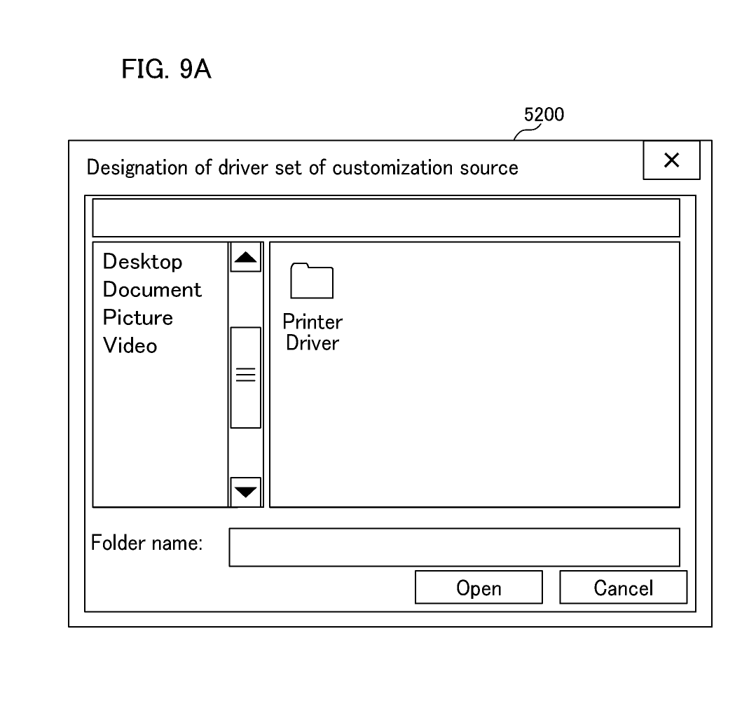

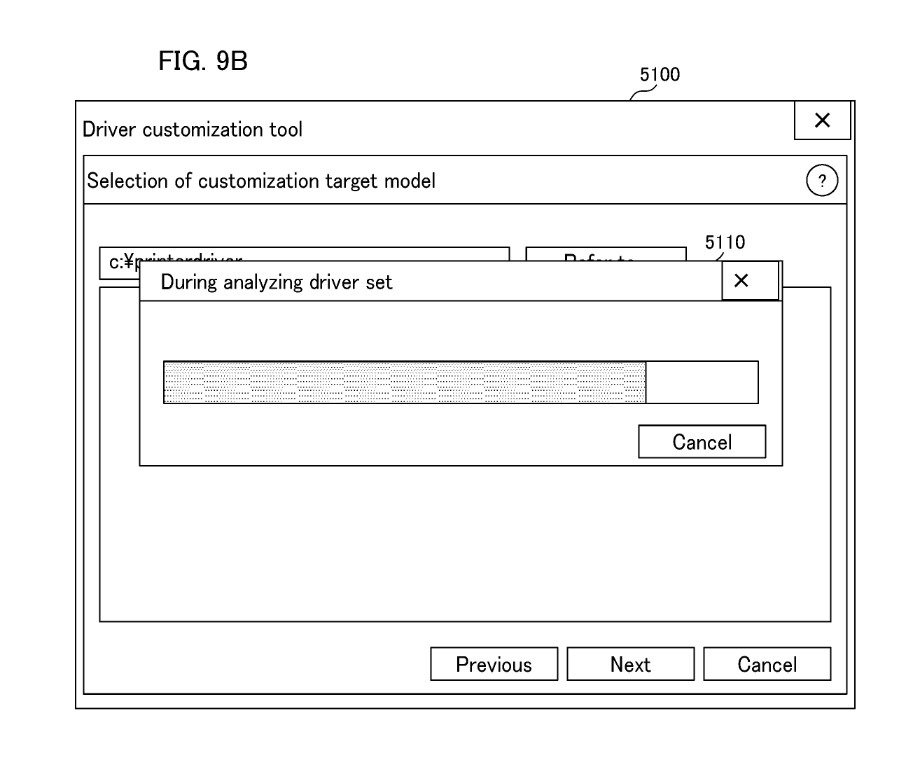

First, the tool 10531 displays a use permission dialog 5000 illustrated in FIG. 8A on the monitor 110 (step S401). Then, pressing of a “Yes” button 5001 is received from the user using the pointing device 109 and the process proceeds to step S402. Subsequently, in step S402, a model selection dialog 5100 of a customization target illustrated in FIG. 8B is displayed. The model selection dialog 5100 is a dialog for designating a folder path of the driver set 1052 which is a customization source and selecting a customization target model among the models to which the driver set 1052 corresponds. If pressing of a reference button 5101 is received, a folder designation dialog 5200 of an OS standard illustrated in FIG. 9A is displayed. In this display, the tool 10531 requests the OS 1054 that the OA 1054 displays the folder designation dialog 5200 illustrated in FIG. 9A on the monitor 110. Then, designation of a folder by the user is received.

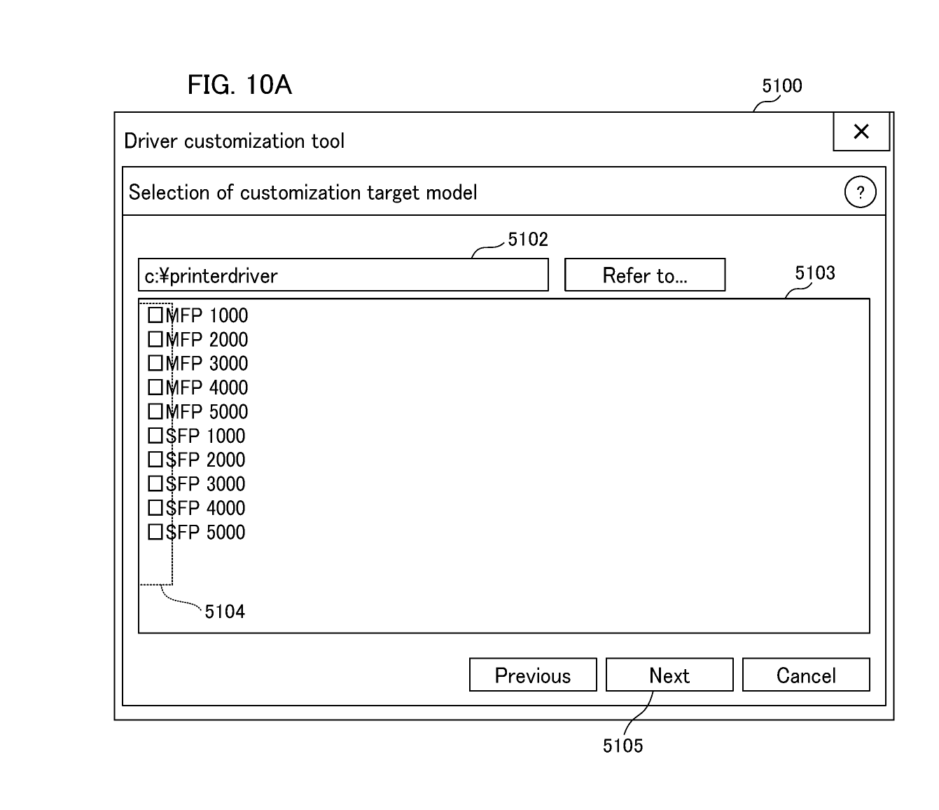

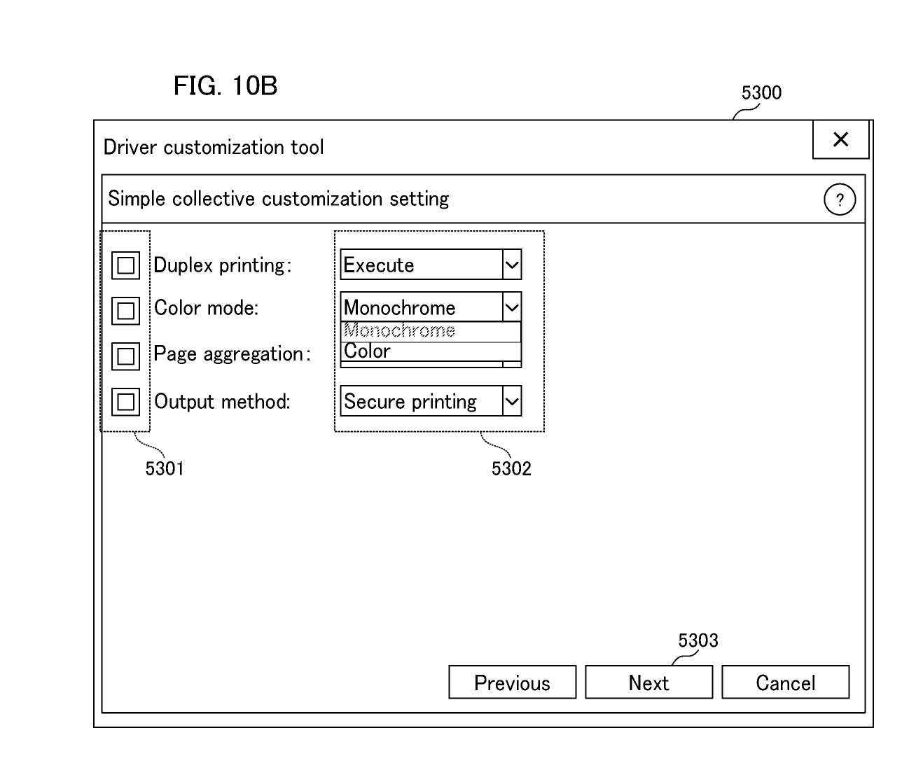

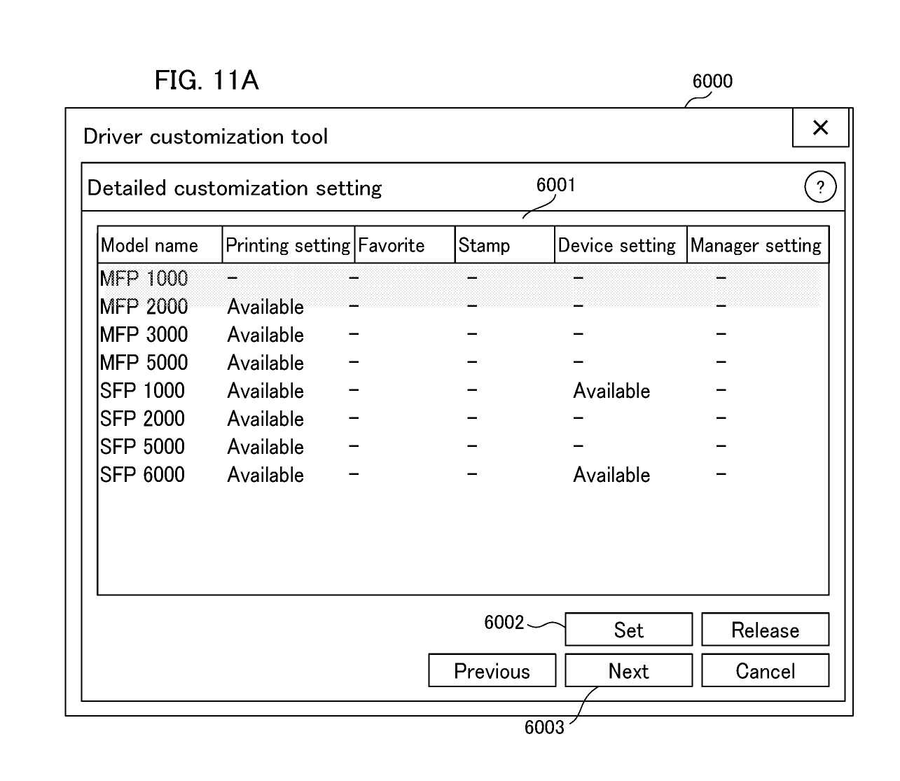

If designation of the folder by the user using the pointing device 109 is received, the OS 1054 returns information regarding the folder path of the driver set 1052 which is the customization source to the tool 10531. The tool 10531 confirms whether the driver set 1052 located at the position of the folder path corresponds to the customization tool 1053. That is, the confirmation process is executed based on the configuration of the driver set 1052 or the description of the INF file 105221 and presence or absence of an Export function of the driver UI module 105222. It takes some time to execute the confirmation process, a decompression process if each module of the driver set 1052 is compressed and stored, and a process of copying backup files in some cases. Therefore, during the process, a progress dialog 5110 indicating a process progress situation illustrated in FIG. 9B is displayed on the model selection dialog 5100. If the tool 10531 determines that the driver set 1052 can be customized, the model selection dialog 5100 of the customization target illustrated in FIG. 10A is displayed on the monitor 110.

The designated folder path is displayed in a text box 5102 and the names of models corresponding to the driver set 1052 in the designated folder path are listed in a list box 5013. A check box 5104 is in front of each model name in the list box 5013. If one or more check boxes 5104 of models desired to be set as customization targets are checked, a “Next” button 5105 can be manipulated. The pressing is received and the tool 10531 causes the process to proceed to step S403. The models checked in the check box 5104 are a model group designated as the customization targets.

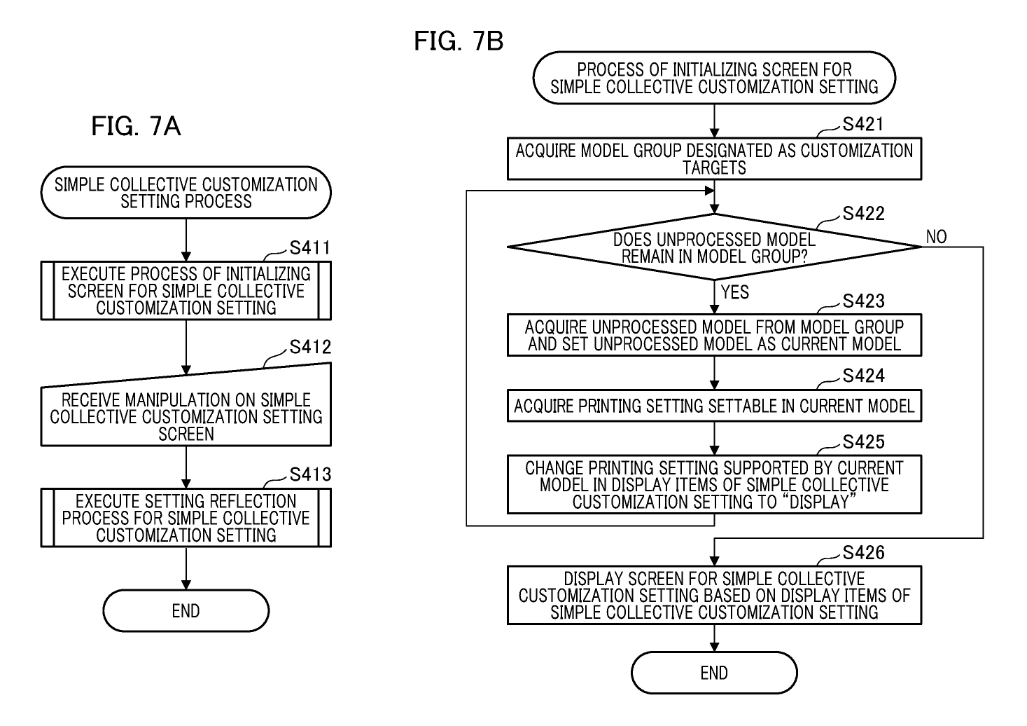

Subsequently, the tool 10531 executes the simple collective customization setting process (step S403). The simple collective customization setting process is a process in which printing setting of which a customization frequency is high can be collectively set. The simple collective customization setting process will be described in detail with reference to the flowchart of FIG. 7A. The simple collective customization setting process is configured to mainly include three processes. First, the tool 10531 executes a process of initializing a screen for the simple collective customization setting illustrated in FIG. 7B (step S411). The tool 10531 acquires a model group designated as the customization targets designated in the check boxes 5104 of the model selection dialog 5100 of the customization target (step S421). Subsequently, the model group designated as the customization target is processed in a loop from step S422 to step S425. First, if the model unprocessed in the model group remains in step S422 (Yes), the process proceeds to step S423. Then, the unprocessed model is acquired from the model group and is set as a current processing target model (step S423). The tool 10531 acquires a printing setting group supported by the current models with reference to files of the current models of a group of the model type-dependent files 105224 which are constituent elements (step S424).

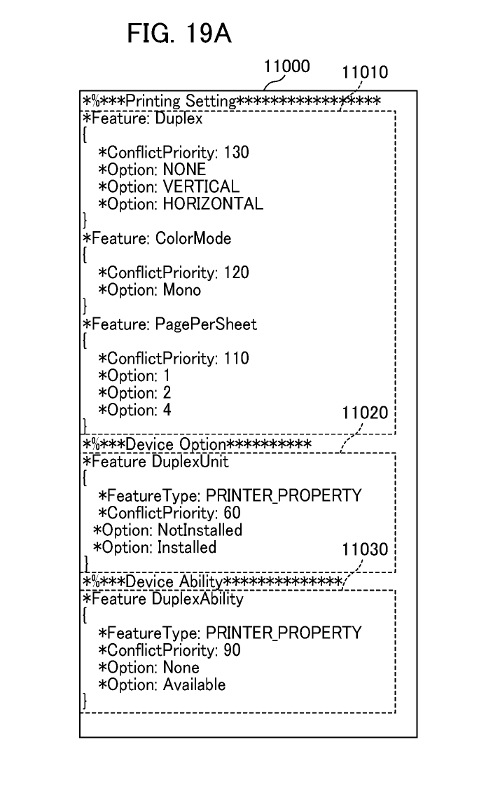

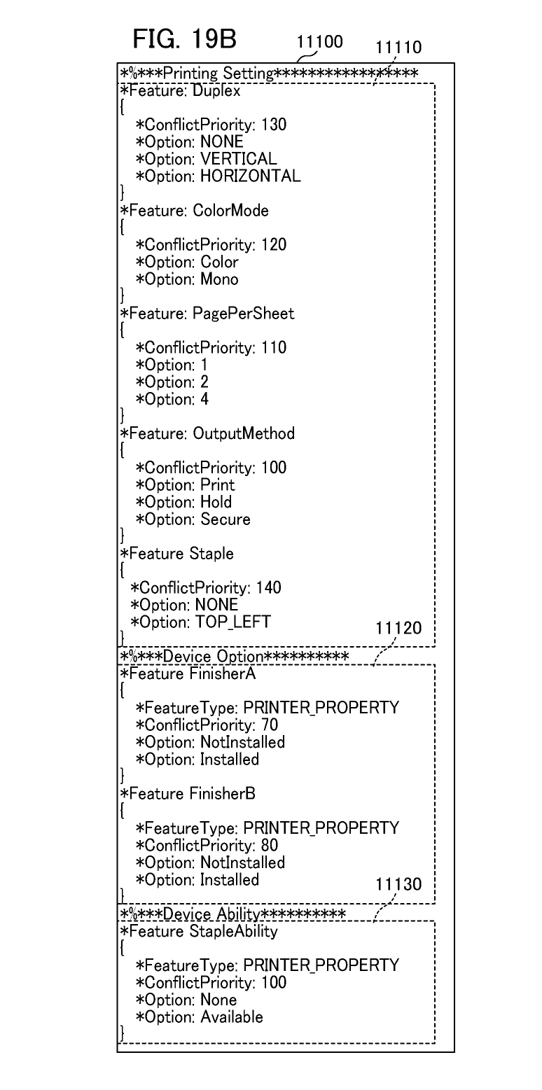

The printing setting group supported by the current models is described in the model type-dependent file 105224. For example, FIG. 19A illustrates a model type-dependent file 11000 for the SFP and FIG. 19B illustrates a model type-dependent file 11100 for the MFP. In the model type-dependent file 105224, the printing setting supported by the model, the device option, and the device ability are described. The printing setting supported by the model is defined after a keyword “*Feature:”. In the model type-dependent file 11000 for the SFP, duplex printing (Duplex), a color mode (ColorMode), and page aggregation (PagePerSheet) are described as information 11010 regarding the printing setting from the upper side. As information 11110 regarding printing setting for the MFP, an output method (OutputMethod) and stapling (Staple) are described in addition to an example of the SFP. Optional settings which are choices for each printing setting are defined after a keyword “Option:”. Further, in each printing setting of the information 11010 regarding the printing setting, an integer is defined after a keyword “ConflictPriority:”. If this value is not able to be set simultaneously between the printing settings, a priority in which a conflict state is resolved is described. As the numerical value is smaller, the priority of the printing setting is higher.

If a conflict in the printing settings occurs, the conflict in the printing settings are resolved by changing the printing setting in which a priority of a large numerical value is low to an initial state. In addition, the model type-dependent file 105224 describes device option information such as a discharge option or a duplex unit in accordance with the same description method as the information regarding the printing setting and a device ability indicating that the device has an ability of the duplex printing or the stapling. In the model type-dependent file 11000 for the SFP, the duplex unit (DuplexUnit) and the duplex printing ability (DuplexAbility) are described as device option information 11020 and a device ability 11030, respectively. In the model type-dependent file 11100 for the MFP, a finisher A (FinisherA) and a finisher B (FinisherB) are described as the device option information 11020. In addition, a stapling ability (StapleAbility) is described as a device ability 11130.

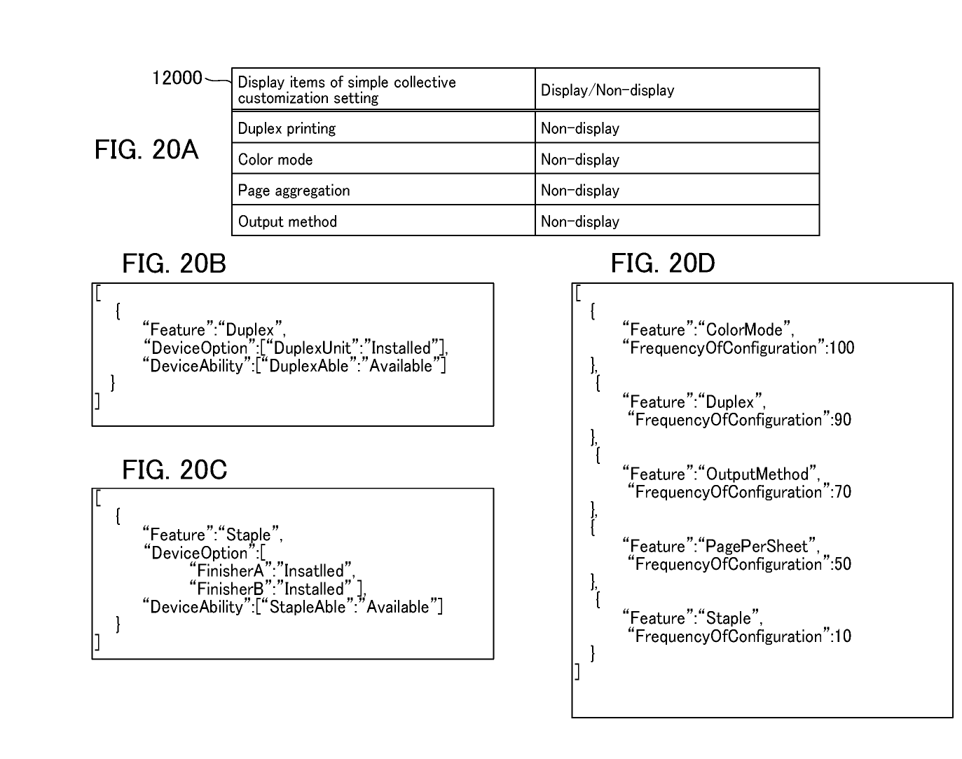

Here, the process of initializing the screen for the simple collective customization setting in FIG. 7B will be described again. The tool 10531 analyzes the model type-dependent file 105224 and acquires the printing settings supported by the current models. Items displayed as display items of the simple collective customization setting are decided using the acquired printing settings of the current models. Here, FIG. 20A illustrates an example of management data 12000 of display items of the simple collective customization setting. In the embodiment, as the simple collective customization setting, duplex printing, a color mode, page aggregation, and an output method can be collectively set as customization setting of a plurality of models. In particular, in the simple collective customization setting, a customizable setting is not limited to the printing setting and as many as possible printing settings of basic common functions supported by the plurality of models may be set. For example, as a printing function, a forcing function such as “forcing duplex printing” ma be set as a simple collective customization setting target. In the embodiment, each initial value of the management data 12000 of the display items of the simple collective customization setting is set to “Non-display.”

Subsequently, the display items of the customization setting supported in the current model are changed to “Display” (step S425). For example, if an SFP corresponding to the model type-dependent file 11000 is selected as the current model, the duplex printing, the color mode, and the output method are changed to “Display.” Then, after all the models designated as the customization target are processed in the loop from step S422 to step S425 (that is, “No” in step S422), the tool 10531 causes the process to proceed to step S462. In step S426, a simple collective customization setting dialog (screen) 53000 illustrated in FIG. 10B is displayed based on the management data 12000 of the display items of the simple collective customization setting.

Here, in FIG. 20A, a UI control for setting the management data 12000 of the display items of the simple collective customization setting is disposed in a simple collective customization setting dialog 5300. A UI control for setting the customization setting of the printing setting corresponding to at least one model in the model group designated as the customization targets is displayed. A UI control of the customization setting for which there is no supporting model in the model group designated as the customization target is in a non-display state and is not displayed. For example, if the model designated as the customization target is only the SFP in FIG. 19A, a UI control of the “output method” is not displayed. Thereafter, the tool 10531 ends the process of initializing the screen for the simple collective customization setting.

Here, referring back to the flowchart of FIG. 7A, the tool 10531 receives a manipulation input on the simple collective customization setting dialog 5300 (a reception way instep S412). In the simple collective customization setting dialog 5300, a check box 5301 is located in front of each customization setting. If the check box 5301 of each printing setting is checked, a corresponding dropdown control 5302 can be manipulated and the customization setting of the corresponding printing setting can be made. After the manipulation of the customization setting is received, pressing of a “Next” button 5303 is received. Then, the tool 10531 executes a setting reflection process for the simple collective customization setting (step S413).

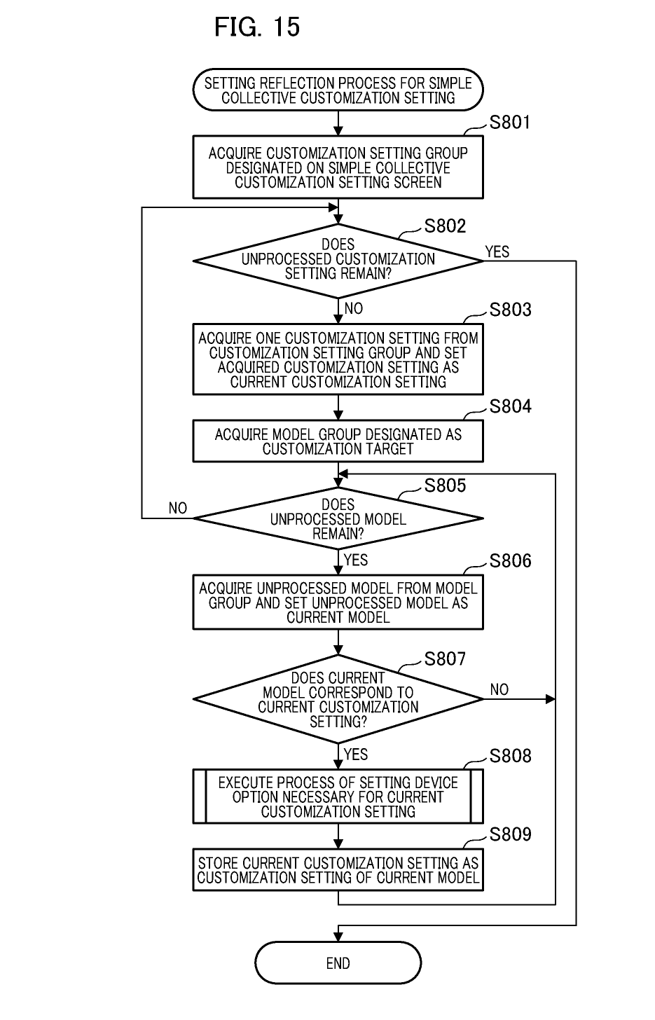

The details of the setting reflection process for the simple collective customization setting (step S413) will be described with reference to FIG. 15. First, the tool 10531 acquires a customization setting group designated in the simple collective customization setting dialog 5300 (step S801). Subsequently, in step S802, if the unprocessed customization setting remains in the customization setting group designated in the simple collective customization setting dialog 5300 (Yes), the process proceeds to step S803. If all the customization settings are processed (No), the process ends. Subsequently, in step S803, one unprocessed customization setting is acquired from the customization setting group and is set to a current customization setting. Subsequently, the tool 10531 acquires a model group of the customization target designated in the model selection dialog 5100 of the customization target (step S804).

Subsequently, if there is the unprocessed model in the model group of the customization target in step S805 (Yes), the process proceeds to step S806. Conversely, if all the models in the model group of the customization target are processed (No), the process returns to step S802 and the process for the subsequent customization setting is executed. Subsequently, in step S806, one unprocessed model in the model group of the customization target is acquired and is set as a current model. Subsequently, if the current model corresponds to the current customization setting (Yes), the process proceeds to step S808. Conversely, if the current model does not correspond to the current customization setting (No), the process returns to step S805 to process a subsequent model.

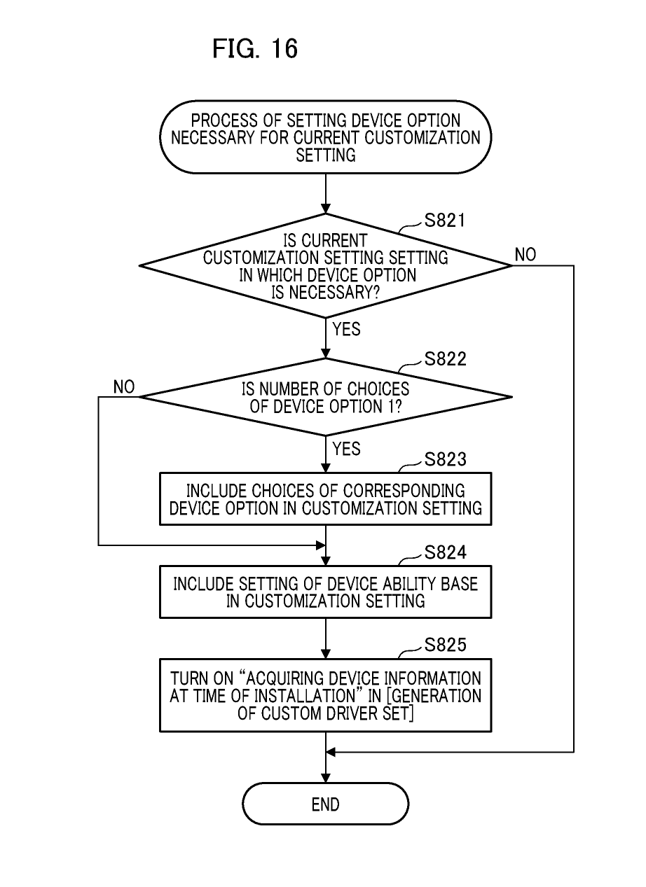

Subsequently, in step S808, a process of setting the device option necessary for the current customization setting is executed. This process will be described with reference to the flowchart of FIG. 16. First, the tool 10531 determines whether the device option is necessary for the current model to execute the current customization setting (step S821). In the embodiment, the device option and the device ability necessary for each customization setting are stored in the tool data 10532 of the customization tool 1053 for each model. Here, FIG. 20B illustrates description of information regarding the device option and the device ability necessary for each customization setting in the case of the SFP in FIG. 19A. FIG. 20C illustrates description of information regarding the device option and the device ability necessary for each customization setting in the case of the MFP in FIG. 19B.

In FIG. 20B, it is indicated that the duplex unit (DuplexUnit) is necessary as a device option (DeviceOption) for the purpose of duplex printing (Duplex). Necessity of a duplex printing ability (DuplexAble) is described as the device ability (DeviceAbility). In FIG. 20C, necessity for the finisher A (FinisherA) or the finisher B (FinisherB) and a stapling ability (StapleAble) which is a device ability is described for the purpose of the stapling (Staple).

Referring back to step S821, the tool data 10532 of the current model is analyzed. If the current customization setting is described (Yes), the process proceeds to step S822. Conversely, if the current customization setting is not described (No), the process of setting the device option necessary for the current customization setting ends. Subsequently, in step S822, it is determined whether the number of device options for validating the current customization setting described in DeviceOption is 1 in the tool data 10532 of the model. If the number of device options is only one (Yes), the process proceeds to step S823 and choices of the corresponding device option are included in the customization setting of the current model. Conversely, if the number of device options is not one (No), the device option remains unset and the process proceeds to step S824.

Subsequently, a setting value of a device ability base described in DeviceAble is included in the customization setting (step S824). Then, setting of “acquisition of the device information at the time of installation” is turned on if a custom driver set is generated (step S825). The reason for turning on this setting is that there is a possibility that an environment in which a customization driver is actually installed to execute printing is different from an environment in which the customization tool 1053 is used to execute a current customization work. If the duplex unit is not mounted on an actual printer at the time of on-installation of the duplex unit, the PDL of the duplex printing is transmitted to the printer at the time of printing. In this case, a printing result output from the printer 200 is finally the simplex printing. However, since the printing setting collected by the client computer is the duplex printing, there is a possibility of an influence on aggregate data in which a printing situation is analyzed. Accordingly, setting of “acquisition of device information at the time of installation” in which communication with the device is executed at the time of installation and a mounting situation of the device option is confirmed is turned on so that the device option according to an installation environment is reflected. Thereafter, the process of setting the device option necessary for the current customization setting ends.

Here, referred back to step S809 (a storage way) of FIG. 15, the current customization setting is stored as a customization setting of the current model in the driver set 1052 (in the printer driver set). Then, if the process ends on all the customization settings designated in the simple collective customization setting in all the models designated as the customization target (“No” in step S802), the process ends. That is, the simple collective customization setting process (step S403) ends on the setting reflection process for the simple customization setting.

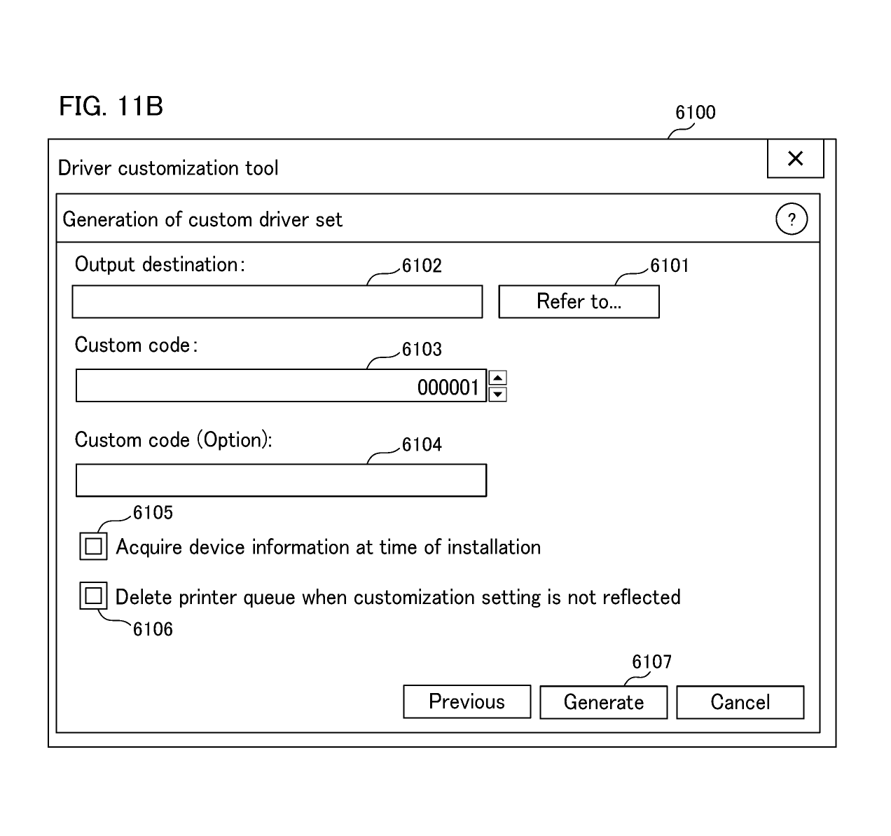

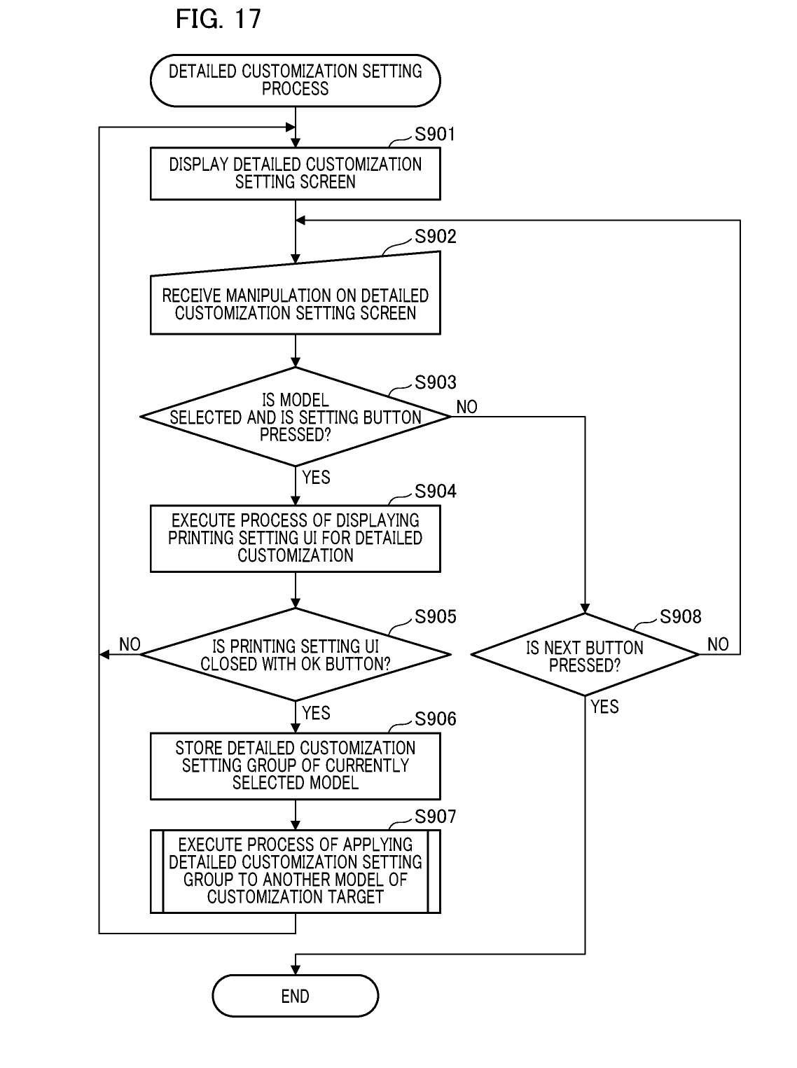

Subsequently, referring back to FIG. 6, the tool 10531 executes the detailed customization setting process in step S404. The details of this process will be described with reference to the flowchart of FIG. 17. First, the tool 10531 displays a detailed customization setting dialog 6000 illustrated in FIG. 11A (step S901) and receives a manipulation on the detailed customization setting dialog 6000 (step S902). The detailed customization setting dialog 6000 includes a list view 6001 in which the model group designated as the customization target is displayed. In the list view 6001, one model enters the selection state and the model in the selection state can be changed by the pointing device 109. In the list view 6001, customization information of printing settings, a favorite, stamp, a device settings, and administrator settings is indicated. If the customization is executed in a corresponding item, a letter “Available” is displayed.

If pressing of a setting button 6002 is received in the selection state of one model in the list view 6001 (“Yes” in step S903), the printing setting UI 3000 of the model in the selection state illustrated in FIG. 4 is displayed for the detailed customization (step S904). The process of displaying the printing setting UI 3000 is realized by calling the driver UI module 105222 using the pseudo-API module 10533 which is an emulator of OS processing. If the driver UI module 105222 is called, the customization setting executed in the simple collective customization setting dialog 5300 is delivered. Thus, the customization setting set in the simple collective customization setting dialog 5300 can be applied to initial display of the printing setting UI 3000.

Since a known display method is used as a method of displaying the printing setting UI 3000, the details of the method will not be described. A process of generating the printing setting and a response of a manipulation to the printing setting UI 3000 is executed by the driver UI module 105222. In the printing setting UI 3000, the driver UI module 105222 included in the driver set 1052 is used. Therefore, the printing setting can be executed with the same manipulation sensibility as the manipulation of the printing setting from a normal app. As a result, the printing setting can be obtained as the customization setting. Here, since the printing setting UI 3000 is not an actual printing environment, there is no printer queue on the OS 1054 and IP address information for communication with a printer is not obtainable. Therefore, even if a device information acquisition button 3202 in FIG. 5 is pressed, the communication with the printer fails and the device option information from the printer is not obtainable. Thus, in the embodiment, an IP address setting button 3204 is disposed in the printing setting UI 3000.

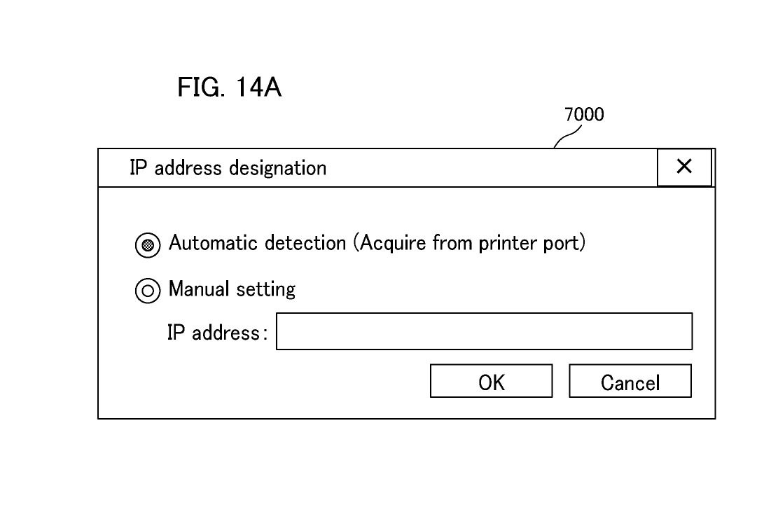

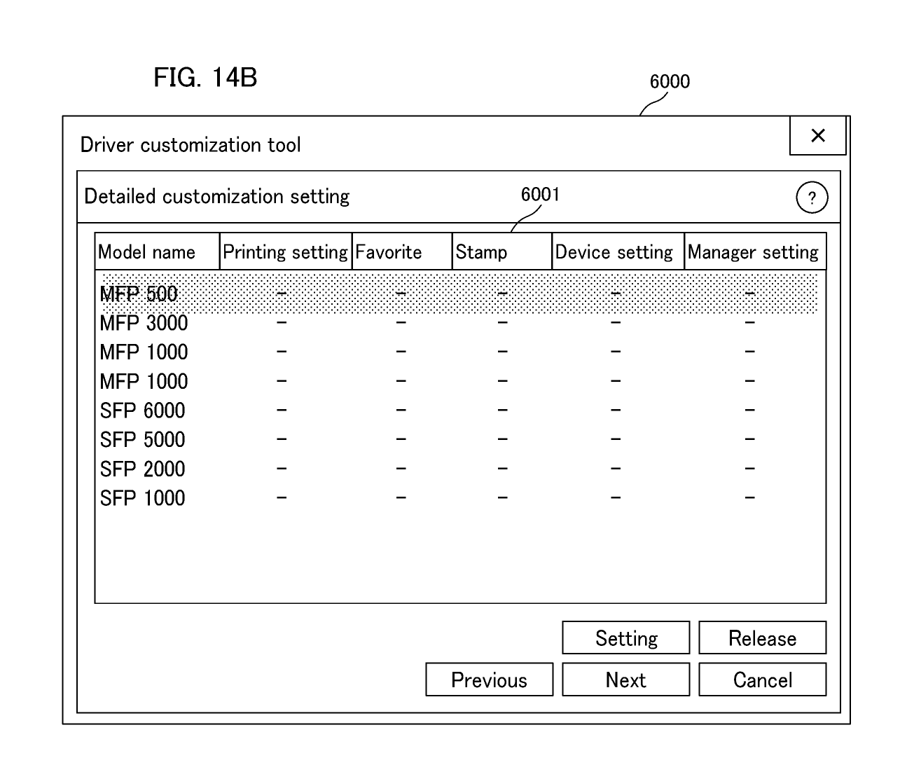

If the driver UI module 105222 receives pressing of the IP address setting button 3204, an IP address setting dialog 7000 illustrated in FIG. 14A is opened. In the IP address setting dialog 7000, “manual setting” is selected, an IP address of the actual printer 200 in the customization environment is designated in the IP address, an OK button is pressed, and the IP address setting dialog 7000 is closed. Thereafter, if the pressing of the device information acquisition button 3202 is received, the device option list is updated. Accordingly, for example, if the same device option configuration as the device option configuration of the printer in an environment in which the customization driver is installed is disposed, an appropriate device option can be included in the customization setting.

If pressing of the OK button 3001 of the printing setting UI 3000 is received, the driver UI module 105222 delivers the printing setting set in the printing setting UI 3000 and information indicating that the OK button 3001 is closed. Thereafter, a process execution right is returned to the tool 10531. If the printing setting UI 3000 is closed with the OK button 3001 (“Yes” in step S905), the tool 10531 causes the process to proceed to step S906. Then, the printing setting received from the driver UI module 105222 is stored as the customization setting of the currently selected model. The subsequent process of step S907 will be described below according to a second embodiment. Subsequently, if a “Next” button 6003 is pressed in the detailed customization setting dialog 6000 (“No” in step S903 and “Yes” in step S908), the detailed customization setting process ends.

As the final step of the customization process in the customization tool, the tool 10531 executes a process of outputting the custom driver set (step S405). The tool 10531 displays a custom driver set generation dialog 6100 illustrated in FIG. 11B. The custom driver set generation dialog 6100 includes a reference button 6101 for designating an output destination folder path of the custom driver set.

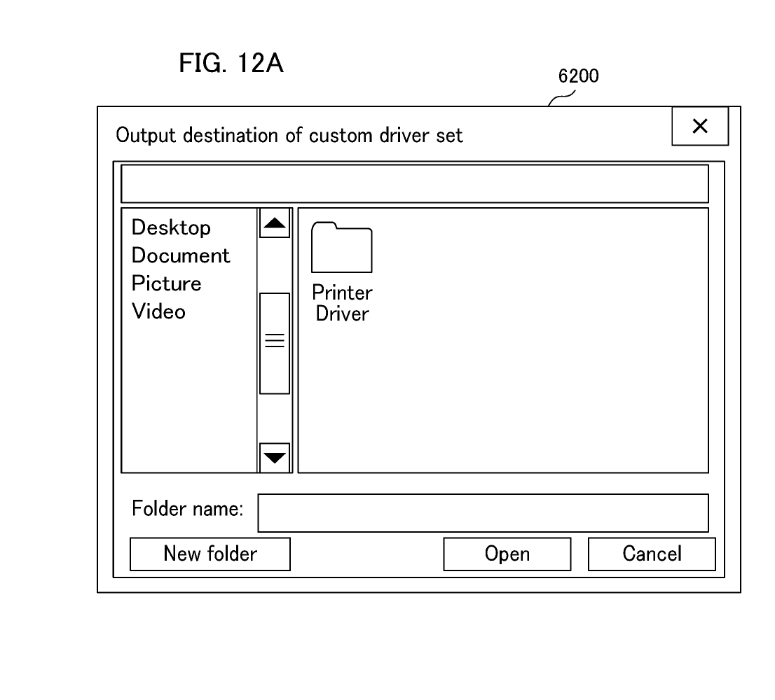

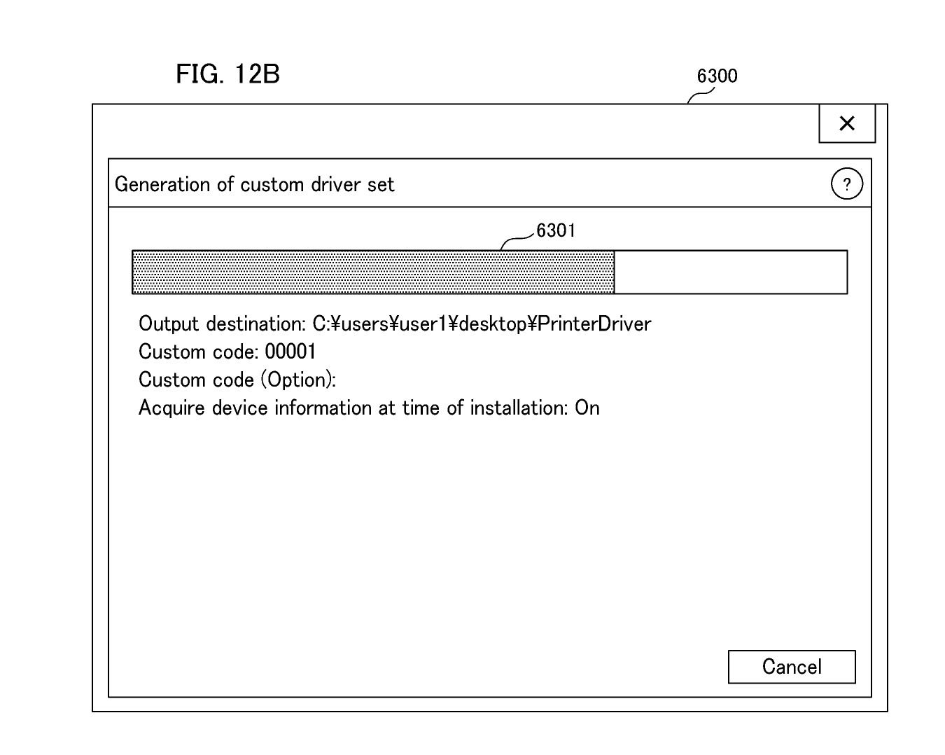

If pressing of the reference button 6101 is received, a folder designation dialog 6200 of the OS standard illustrated in FIG. 12A is displayed. The folder designation dialog 6200 is displayed by making a request to the OS 1054 by the tool 10531 and the OS 1054 receives a manipulation of designating a folder in the folder designation dialog 6200. If a designation manipulation with the pointing device 109 is received, the OS 1054 returns information regarding the folder path to the tool 10531. The information regarding the folder path returned from the OS 1054 is received and the tool 10531 displays the information regarding the folder path in the text box 6102 of an output destination. The custom driver set generation dialog 6100 includes UI controls 6103 and 6104 for designating a customization code to receive a customized number and a comment.

The custom code received in the control is stored as the customization setting file 10523 in the customized driver set 1052. After the driver 10522 is installed, the driver 10522 can be confirmed with a dialog displayed if a version information button 3205 of the printing setting UI 3000 is pressed. Further, the custom driver set generation dialog 6100 includes a check box 6105 “Acquire device information at installation time.” In the embodiment, the check box 6105 “Acquire device information at time of installation” is turned off in an initial state since it takes a communication time with the printer 200. If step S825 of FIG. 16 is executed, the check box 6105 is turned on to acquire the device option of the printer 200 of an installation destination of the driver 10522.

Further, the custom driver set generation dialog 6100 includes a check box 6106 “Delete printer queue if customization setting is not reflected.” If the check box 6106 is turned on, the customization setting is applied to a printer queue. If the customization setting is not reflected, the printer queue is deleted. The details thereof will be described according to a fourth embodiment. Pressing of a generation button 6107 of the custom driver set generation dialog 6100 is received and the tool 10531 displays a custom driver set generation progress dialog 6300 illustrated in FIG. 12B on the monitor 110. In the generation of the custom driver set, it is necessary to generate another driver set by wholly copying the driver set in order to protect the driver set based on the customization driver. Execution of this process takes a relatively long time. Therefore, the custom driver set generation progress dialog 6300 displays a progress situation of a process with a progress bar 6301. Finally, the customization settings generated in the simple collective customization setting process (step S403) and the detailed customization setting process (step S404) are stored as the customization setting file 10523 in the driver set 1052. That is, insteps S403 and S404, data including a command of a setting change to a value of the printing setting changed through a manipulation on the received simple collective customization setting dialog 5300 is generated. Then, the generated data is stored as customization information in the driver set 1052 (in the printer driver set).

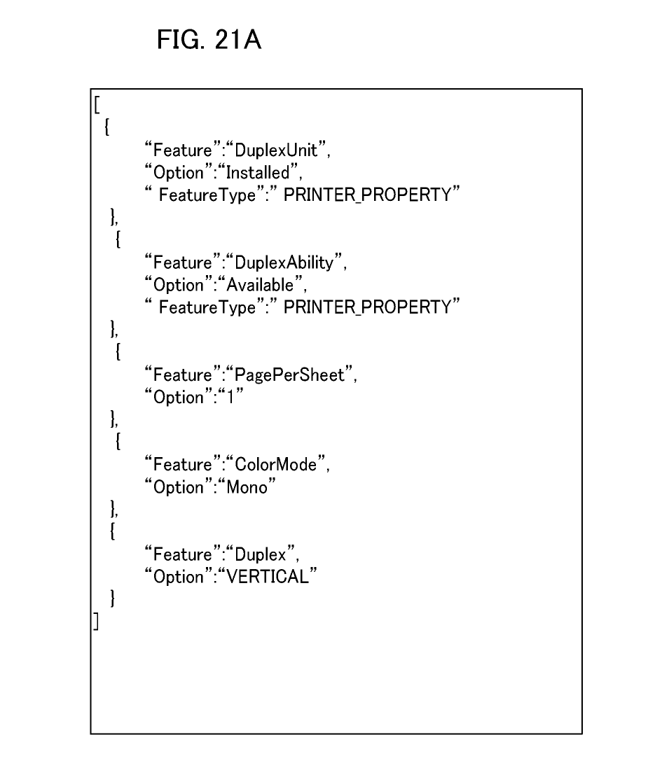

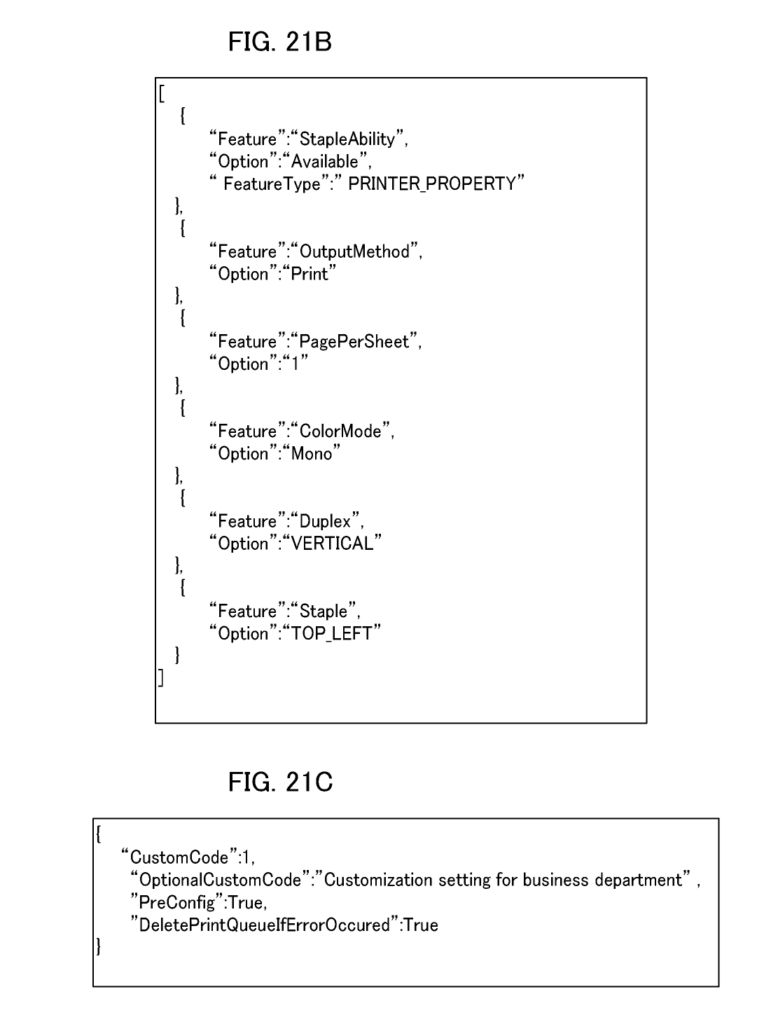

An example of the setting of the customization setting file 10523 in the SFP is illustrated in FIG. 21A. In FIG. 21A, the customization settings of the duplex unit: available, customization setting of the duplex ability: available, the page aggregation: 1 on 1, the color mode: monochrome, and the duplex printing: long-side binding are illustrated from the upper side of the file. FIG. 21B illustrates an example of the setting on the MFP. In this case, the customization settings of the stapling ability: available, the output method: normal printing, the page aggregation: 1 on 1, the color mode: monochrome, and the duplex printing: long-side binding, and the stapling: top left are illustrated. “FeatureType”: “PRINTER_PROPERTY” is described in the device option and the device ability which are in a state distinguished from the printing setting.

The description of the customization setting of the customization setting file 10523 is stored in the process of step S906 so that the fact that the customization setting in which the priority is higher and a conflict state of the printing setting illustrated in FIGS. 19A and 19B is resolved is located in front of a file. In a customization setting application process in the installer 10521, the customization setting is applied from the head of the customization setting file 10523. Therefore, the customization setting is applied to printer queues in order from the customization setting with a higher priority. Even if a conflict state occurs in the conflict state, the customization setting which is a changing target in a rounding process is the customization setting which is currently attempted to be executed and the already executed customization setting is not changed. As a result, in a state in which a calculation amount is less, the customization setting can be applied.

Next, FIG. 21C illustrates an example of the common customization setting file 10523 of the custom driver set. “CustomCode” and “OptionalCustomCode” retain information regarding custom options set with the custom code 6103 and the custom code (option) 6104 of the custom driver set generation dialog 6100. The information regarding the customization option is information indicating whether there is the customized driver. This information is registered in all the queues to which the customization setting is applied.

“PreConfig” is a customization setting in which the setting of the check box 6105 is stored. If “PreConfig” is “True” and a printer queue is generated by the installer 10521, communication is executed via the printer 200 and the network 300 and option information regarding the device mounted on the current printer 200 is acquired. Through this operation, the information regarding the device option of the actually installed printer can be reflected. Conversely, if “PreConfig” is “False,” that is, the check box 6105 is turned off, the option information regarding the device is not acquired. In this case, since a communication process of the device is not executed, a required time of the installation process is short. As described above, however, in an environment in which aggregate data is collected to analyze a printing situation, a difference occurs between an actual printing result and the aggregate data.

If there is a device option necessary for the current customization setting, a process of changing an initial value of the check box 6105 to be turned on is added. In an environment in which the aggregate data is not acquired, the check box 6105 is not set to be unchangeable and can be changed by a manual setting for a user who desires to shorten a required time of the installation process. Further, “DeletePrintQueueIfErrorOccurred” is described in the common customization setting file 10523. This is a customization setting in which the state of the check box 6106 is stored. If “DeletePrintQueueIfErrorOccurred” is “True” and the customization setting may not be reflected in the printer queue by the installer 10521, an installed printer queue is deleted. The details of this process will be described below in the fourth embodiment.

In the related art, as in the manipulation of the detailed customization setting process, one model is selected, the printing setting UI is displayed, and the customization setting is individually generated. Therefore, it is necessary to repeat the same customization setting as many times as the number of models designated as the customization target. If the number of models of the customization target is large, a setting labor is taken. In the embodiment, however, by realizing the simple collective customization setting process, it is possible to apply a setting to be well customized (that is, a printing setting in which a customization frequency is relatively high) collectively to a plurality of models of printers. By performing the process of setting a device option necessary for the current customization setting, it is possible to automatically include the device option or the device ability necessary for the customization setting in the customization setting. Accordingly, the customization setting for which it is necessary to execute the customization setting after the device option is manually set in the related art can also be executed without minding the setting of the device option.

### Second Embodiment

In the first embodiment, the printing setting in which the customization frequency is relatively high can be applied collectively to the plurality of models of printers through the simple collective customization setting process. In a second embodiment, a method of applying a detailed customization setting such as stapling further set in the detailed customization setting process to other models of printers will be described.

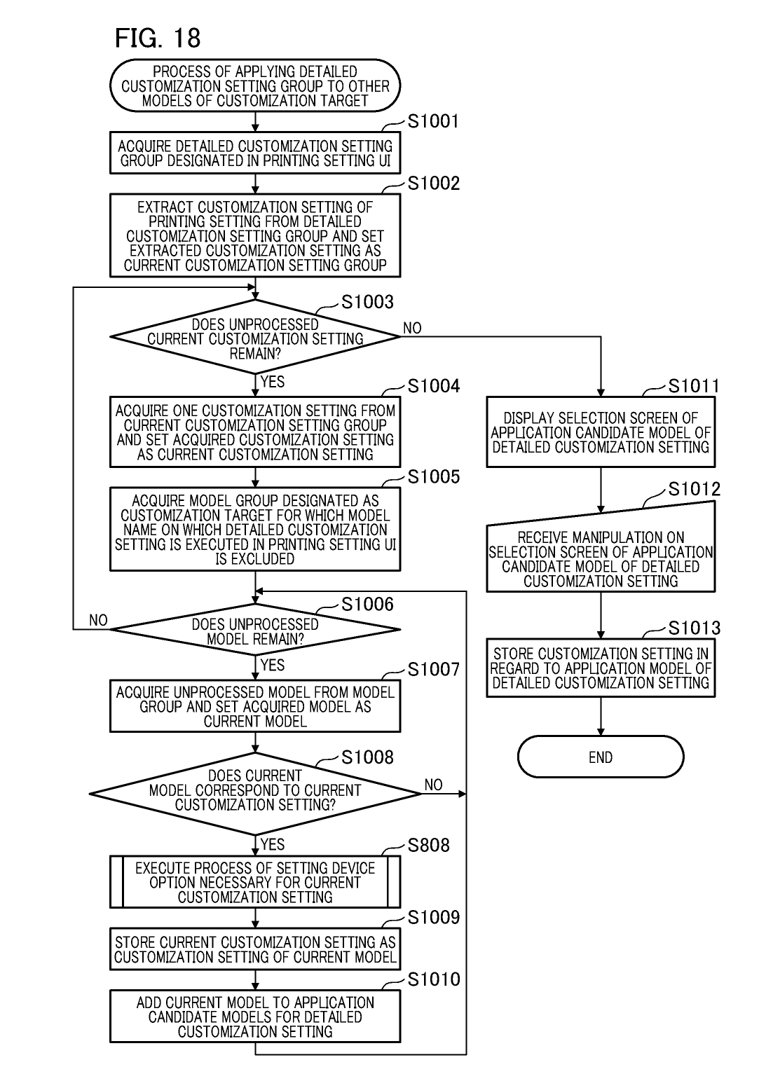

The method of applying the detailed customization setting to other models of printers will be described with reference to the flowchart of FIG. 18. This process is executed on the currently selected model in the process of step S907 after the detailed customization setting group is decided in the detailed customization setting process described in FIG. 17. First, the tool 10531 acquires a detailed customization setting group designated in the printing setting UI 3000 (step S1001). Next, the customization setting group of the printing setting which is not the device option and the device ability is extracted from the detailed customization setting group and the extracted setting group is set as a current customization setting group (step S1002). In this extraction, attributes of “FeatureType” of the model type-dependent file 11000 illustrated in FIGS. 19A and 19B are used. The setting that has a value of “PRINTER_PROPERTY” with the attributes is the device option and the device ability. Accordingly, a setting that does not satisfy the conditions is extracted from the detailed customization setting group.

Subsequently, if the unprocessed customization setting remains in the current customization setting group in step S1003 (Yes), the process proceeds to step S1004. If all of the customization settings are processed (No), the process proceeds to step S1011. Subsequently, in step S1004, one unprocessed customization setting is acquired from the current customization setting group and the acquired customization setting is set as a current customization setting. Subsequently, in step S1005, the tool 10531 acquires a model group of the customization target designated in the model selection dialog 5100 of the customization target. From the model group of the customization target, a model in which the printing setting UI is displayed in step S904 is extracted from the model group of the customization target and which is set as a model group of the customization target.

Subsequently, if the unprocessed model still remains in the model group of the customization target in step S1006 (Yes), the process proceeds to step S1007. Conversely, if all the models in the model group of the customization target are processed (No), the process returns to step S1003 to execute the process on a subsequent customization setting. Subsequently, in step S1007, one unprocessed model is acquired from the model group of the customization target and is set as a current model.

Subsequently, if the current model corresponds to the current customization setting in step S1008 (Yes), the process proceeds to step S808. Conversely, if the current model does not correspond to the current customization setting (No), the process returns to step S1006 to execute a subsequent model. The details of the process of step S808 have been described in the first embodiment. Therefore, the description thereof will be omitted in the embodiment. By executing this process, a setting of the device option necessary for the current customization setting is decided and stored as the customization setting of the current model.

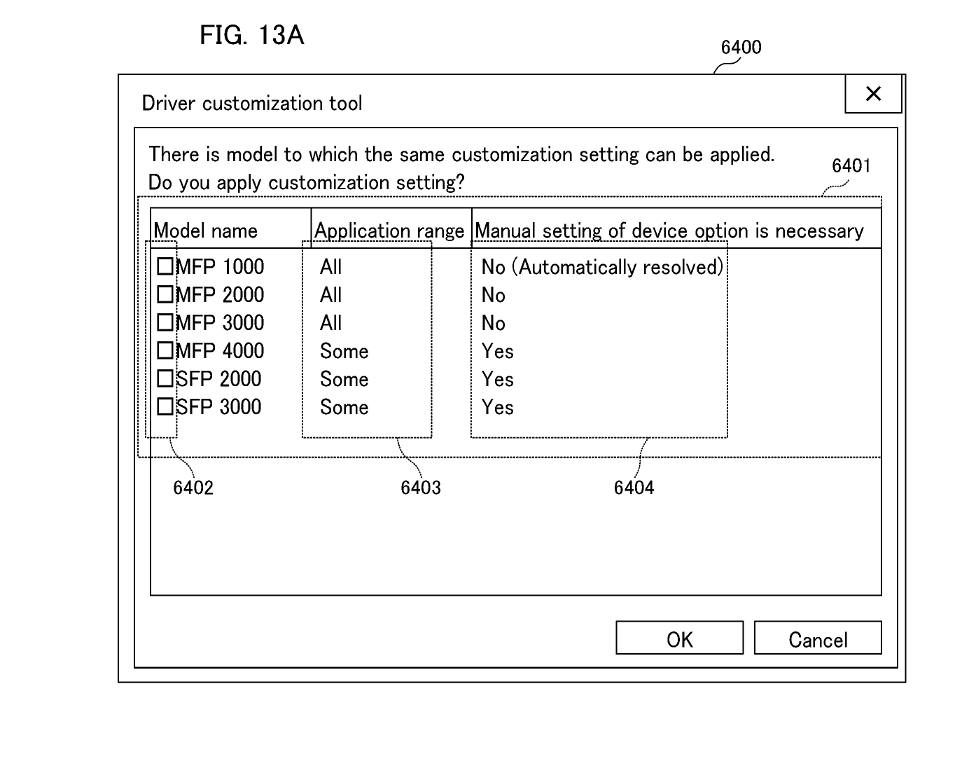

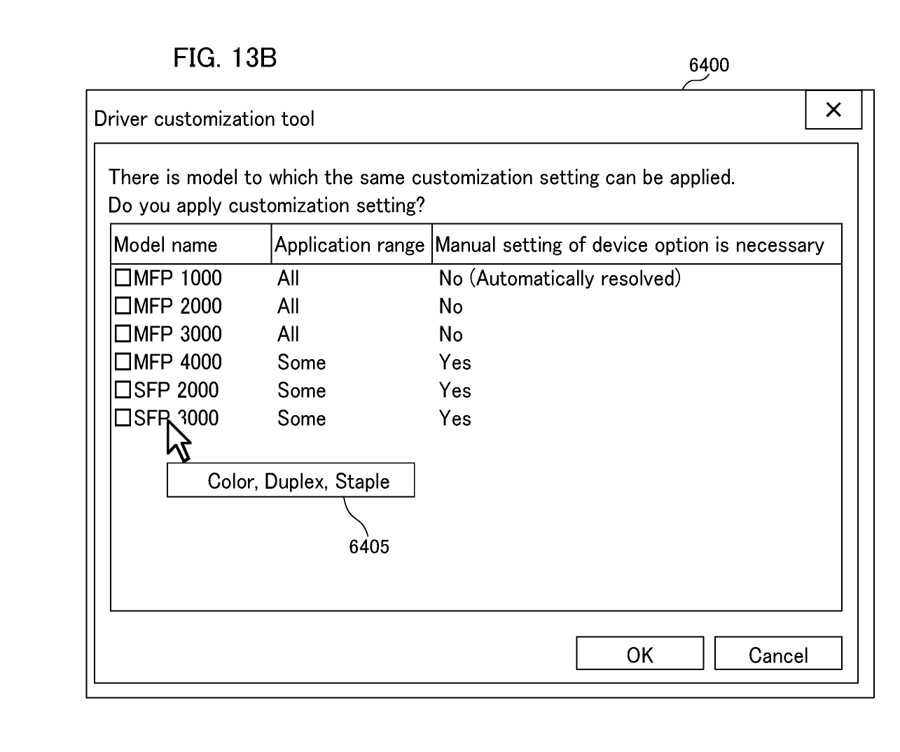

Subsequently, in step S1009, the current customization setting is stored as the customization setting of the current model. Subsequently, the current model is added to application candidate model of the detailed customization setting (step S1010). If the process ends in regard to all the current customization setting groups and all the models (“No” in step S1006 and “No” in step S1003), a selection dialog 6400 of the application candidate models for the detailed customization setting illustrated in FIG. 13A is displayed. The selection dialog (detailed screen) 6400 includes a list box 6401 of model names of printers for which a model is selected in the detailed customization setting dialog 6000 and the customization setting set in the printing setting UI 3000 is applicable.

In the list box 6401, a model added to the application candidate models for the detailed customization setting is displayed in step S1010. To receive an instruction of whether the customization setting is applied to another model from a user, a check box 6402 is disposed in front of a model name of a printer of the list box 6401. Whether all the customization settings are applicable or some of the customization settings are applicable is displayed as information regarding an application range 6403. This information is displayed in the application range 6403 on the selection dialog 6400 (on a detailed screen) according to the detailed customization setting group designated in the printing setting UI in step S1002 and the current customization setting stored in step S1009. That is, if the detailed customization setting group designated in the printing setting UI in step S1002 matches the current customization setting stored instep S1009, “all” is displayed. Otherwise, “some” is displayed in the application range 6403 on the selection dialog 6400.

If a specific application item is desired to be confirmed, as illustrated in FIG. 13B, a tooltip 6405 is displayed by locating a mouse cursor on a corresponding model for a certain time period, and thus the detailed customization setting of application candidates can be confirmed. Further, in the list box 6401, information 6404 indicating whether a manual setting of a device option is necessary is displayed. This information is determined by storing whether selection of a device option is decided uniquely in step S822 of FIG. 16. The tool 10531 receives a manipulation on the selection dialog 64000 of the application candidate model of the detailed customization setting (step S1012). If pressing of an OK button 6045 of the selection dialog 6400 is received, the customization setting is stored in regard to the application model of the detailed customization setting checked in the check box 6402 (step S1013). Thereafter, the process ends.

As described above, according to the embodiment, by determining whether the detailed customization setting executed on one model through the detailed customization setting process using the printing setting UI 3000 can also be set in other models, it is possible to broaden the application range to other models. Thus, the setting procedure of the detailed customization setting which is necessarily set individually in an individual model in the related art can be collectively set.

### Third Embodiment

In a third embodiment, a process of a display procedure of model names of the list view 6001 of the detailed customization setting dialog 6000 illustrated in FIG. 11A will be described. In general, the detailed customization setting is selected from models from the upper side of the list view 6001 and setting is executed in the printing setting UI by pressing the setting button 6002. If models having a function in which a customization frequency is higher are displayed on the upper side of the list view 6001, setting efficiency of the collective setting is improved.

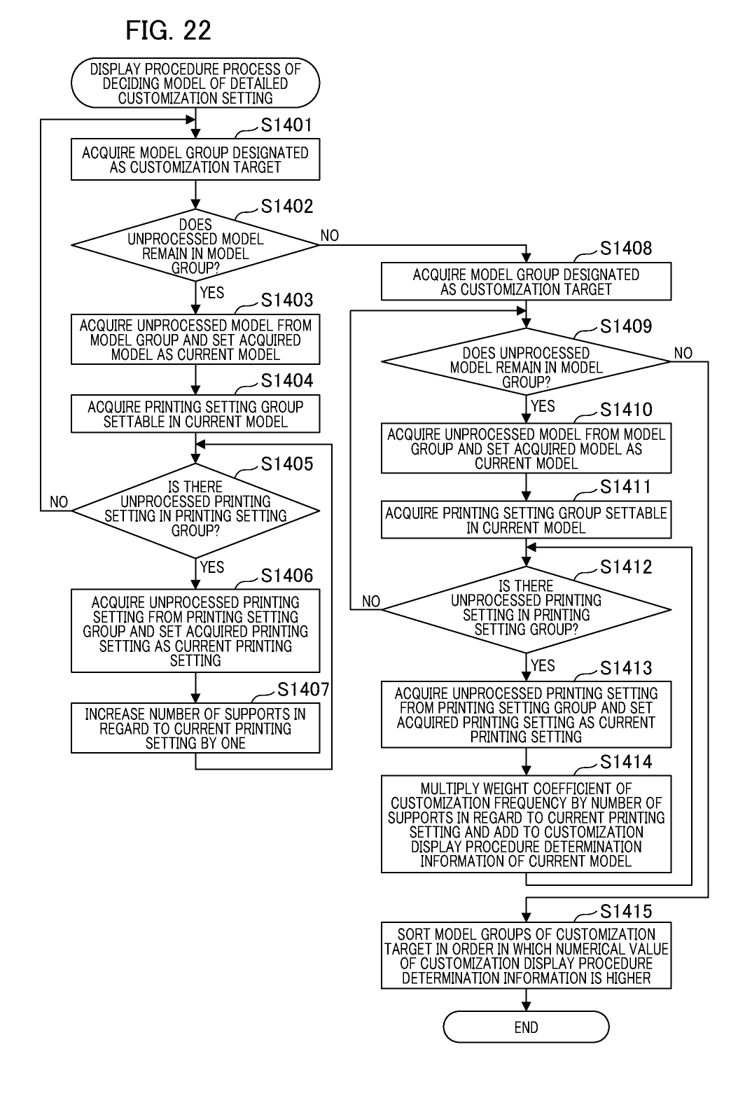

Here, a display procedure deciding process of the models for the detailed customization setting will be described with reference to the flowchart of FIG. 22. This process is executed as a part of step S901 of FIG. 17 by the tool 10531. First, the tool 10531 acquires a model group designated as the customization target in FIG. 10A (step S1401). Subsequently, if an unprocessed model remains in the model group in step S1402 (Yes), the process proceeds to step S1403. Conversely, if all the models are processed (No), the process proceeds to step S1408.

Subsequently, in step S1403, one unprocessed model is acquired from the model group and is set as a current model. Subsequently, a supported printing setting group is acquired from the model type-dependent file 105224 of the current model (step S1404). Then, if an unprocessed printing setting remains in the printing setting group in step S1405 (Yes), the process proceeds to step S1406. Conversely, if all the printing settings are processed (No), the process returns to step S1401 to execute the process on a subsequent model. Subsequently, in step S1406, the unprocessed printing setting is acquired from the printing setting group and is set as a current printing setting. Subsequently, one variable for counting the number of supports of the current printing setting increases in regard to the current printing setting (step S1407). Then, if the processes from steps S1402 to S1407 end on all the models designated as the customization target and the printing setting group supported by each model, the number of supports which is the number of model types supported for each printing setting is aggregated.

Subsequently, the tool 10531 executes the process of step S1408. Here, since the processes from steps S1408 to S1413 are the same as the processes from steps S1401 to S1406, the detailed description thereof will be omitted. That is, the processes from steps S1408 to S1413 are a loop process of processing all the models designated as the customization target and a printing setting group supported by each model. Subsequently, in step S1414, a weight coefficient of the customization frequency in the current printing setting is multiplied by the number of supports of the current printing setting obtained in step S1407. The weight coefficient of the customization frequency is a number by which a frequency to be well customized is predicted in advance by the user. In the embodiment, the weight coefficient is stored as a part of the tool data 10532.

Here, FIG. 20D illustrates an example of the weight coefficient of the customization frequency. For each printing setting (Feature), a weight coefficient of a customization frequency (FrequencyOfConfiguration) is defined. The user allocates a large numerical value to a printing setting which is highly likely to be the customization target. Then, in step S1414, a numerical value further obtained through multiplication is added to customization display procedure determination information regarding the current model. Subsequently, in step S1415, the model groups of the customization target are sorted in an order in which the numerical value of the customization display procedure determination information is higher. Then, the display procedure deciding process of the models for the detailed customization setting ends.

In the related art, the display procedure of the list view 6001 is decided based on a model description order (which is the same order as the order in FIG. 10A) in the INF file 105221, as illustrated in FIG. 11A, or pre-decided information. However, in the embodiment, the display order is different from that of FIG. 11A, as an example is illustrated in FIG. 14B. The models in which the printing settings in which the frequency of the customization setting is considered to be high are more supported in the model group designated as the customization target are displayed in the upper side of the list view 6001 of the detailed customization setting dialog 6000. Accordingly, if the detailed customization setting is executed on the upper side of the list view 6001 according to the embodiment, there is a high possibility of the customization setting expected in an earlier stage applicable to other models.

### Fourth Embodiment

Next, a customization setting application process in the installer according to a fourth embodiment will be described with reference to the flowchart of FIG. 23. This process is executed if a process of activating the installer 10521 included in the customized driver set 1052 illustrated in FIG. 3C is executed. A specific execution timing is a timing after a process of installing a normal printer driver is executed, and the process is executed to apply the customization setting to a printer queue. An entity of the process of the flowchart is the installer 10521 unless otherwise mentioned.

First, instep S1501, the installer 10521 acquires a list of installed printer queues. Subsequently, it is determined whether there is a printer queue to which the customization setting is not applied in the list of the printer queue (step S1502). If there is the printer queue to which the customization setting is not applied (Yes), the process proceeds to step S1503. Then, in step S1503, the printer queue to which the customization setting is not applied is acquired from the list of the installed printer queues and is set as a current printer queue. Subsequently, if the customization setting is executed, it is determined whether the check box 6105 “Acquire device information at time of installation” is turned off (step S1504).

Specifically, description of PreConfig of the common customization setting file 10523 of FIG. 21C included in the customization setting file 10523 of FIG. 3C is confirmed. If “PreConfig” is “True,” the customization setting file of the same model as the current printer queue is searched for from the customization setting file 10523 of FIG. 3C in the current printer queue. The customization setting has been described with reference to FIGS. 21A and 21B. In the embodiment, all the customization settings also including the printing setting, the device option, and the device ability are applied to the current printer queue (step S1505). Specifically, if “PreConfig” is not “True,” the device information is acquired from the corresponding printer 200 based on information regarding the printer queue, and the device option and the device ability are set in the printer queue (step S1506).

After the setting, only the printing setting of the customization setting of the same model is applied to the current printer queue (step S1507). In step S1507, to prioritize the device information acquired from the printer 200, the device option and the device ability of the customization setting are not reflected. In the embodiment, there is description of “FeatureType”: “PRINTER_PROPERTY” in the device option and the device ability of the customization setting. Whether there is the printing setting or another setting in this description can be determined.

Subsequently, if the customization setting is executed, it is determined whether the check box 6106 “Delete printer queue if customization setting is not reflected” is turned off (step S1508). Specifically, description of “DeletePrintQueueIfErrorOccured” of the common customization setting file 10523 of FIG. 21C included in the customization setting file 10523 of FIG. 3C is confirmed. If “DeletePrintQueueIfErrorOccured” is “True” (Yes), the process proceeds to step S1509. In the otherwise case (No), the process returns to step S1502 to execute the process of a subsequent printer queue.

Subsequently, in step S1509, it is determined whether all the printing settings applied in step S1507 are applied. If there is the printing setting which is not applied (Yes), a process of deleting the current printer queue by the OS 1054 is executed in step S1510. If the processes from steps S1504 to S1510 are executed on all the installed printer queues, the installer 10521 ends the customization setting application process in the installer.

In the embodiment, if the check box 6105 “Acquire device information at time of installation” is turned on, the customization setting can be applied in the state in which the device option and the device ability in the actual printer 200 are reflected. Conversely, if the check box 6106 “Delete printer queue if customization setting is not reflected” is turned on, the device option and the device ability in the actual printer 200 are reflected. Thereafter, if the customization setting may not be reflected, the corresponding printer queue is deleted. From the above description, it is possible to prevent installation of the printer queue to which the customization setting is not correctly applied.

### Other Embodiment

In the foregoing embodiments, the data of FIGS. 20A, 20B, and 20D is stored as the tool data 10523 of the customization tool 1053, but it is particularly unnecessary to store the data in the tool data 10532. For example, the data may be stored as the model type-dependent file 105224 in the driver set 1052. A scheme of storing the data in another storage device on a network, executing communication as necessary, and acquiring the data may be used. Accordingly, a data storage position is not limited.

In the foregoing embodiments, the description has been made using the printing settings directly linked to the printing output, the duplex printing or the color mode, as the printing setting of the customization target. In particular, the present invention is not necessarily limited to the printing settings. For example, a printing setting group in which a plurality of printing settings, a favorite and a stamp setting, gather may be stored as one customization setting. A printing restriction setting for enforcing another printing setting such as duplex printing forcing or monochrome printing forcing may be set as a setting of the customization target.

Further, in the foregoing embodiments, the driver set corresponding to the plurality of models of printers has been designated as the driver set which is the customization source with one package. However, customization of a plurality of models may be executed at once by setting a driver set corresponding to a single model a plurality of times with the reference button 5101.

The processes of steps S1506 and S1507 in the fourth embodiment can also be realized by reflecting all the customization settings to the printer queue and subsequently reflecting the device information acquired from the printer 200 to the printer queue. In general, as the device information acquired from the printer 200, the device option or the device ability of which a priority is higher than the printing setting is acquired. Therefore, in the fourth embodiment, there is a high possibility of a conflict state with the printing setting of the customization setting occurring in this method. Therefore, there is a possibility of a processing time being more necessary. In particular, if the processing time does not matter, either method may be used.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-185442, filed Sep. 23, 2016 which is hereby incorporated by reference wherein in its entirety.

What is claimed is:

1. An information processing apparatus comprising:
a first reception unit configured to receive selection of a printer driver set including a plurality of printer drivers corresponding to models of a plurality of printing devices;
a second reception unit configured to receive selection of a model of a customization target from the printer driver set;
a display unit configured to display a screen for customizing printing setting of the printer drivers; and
a generation unit configured to generate customization information based on the customized printing setting received via the screen,
wherein the display unit is configured to be able to display a first screen for collectively customizing a specific printing setting in a plurality of selected models of the customization target and a second screen for individually customizing a printing setting in one selected model of the customization target.

2. The information processing apparatus according to claim 1,
wherein the display unit does not display a printing setting in which the model received by the second reception unit is not supported, on the first screen.

3. The information processing apparatus according to claim 1,
wherein the display unit displays information indicating whether the printing setting supported by the model received by the second reception unit is a printing setting supported by all the models or a printing setting supported by some of the models, on the second screen.

4. The information processing apparatus according to claim 3,
wherein, if a cursor is combined with the model displayed on the second screen, the display unit displays a tooltip indicating the printing setting supported by the model.

5. The information processing apparatus according to claim 1, further comprising:
a storage unit configured to store the generated customization information in the printer driver set,
wherein the storage unit acquires device information of the printing device and stores the acquired device information and the generated customization information.

6. The information processing apparatus according to claim 5,
wherein, if the printing setting is not reflectable to the device information, the storage unit does not store the generated customization information.

7. The information processing apparatus according to claim 1,
wherein the display unit decides a display procedure of items of the printing setting displayed on the second screen based on a weight coefficient of a frequency of the customization and the number of supports.

8. A method of controlling an information processing apparatus, comprising:
receiving selection of a printer driver set including a plurality of printer drivers corresponding to models of a plurality of printing devices;
receiving selection of a model of a customization target from the printer driver set;
displaying a screen for customizing printing setting of the printer drivers; and
generating customization information based on the customized printing setting received via the screen,
wherein the displaying is configured to be able to display a first screen for collectively customizing a specific printing setting in a plurality of selected models of the customization target and a second screen for individually customizing a printing setting in one selected model of the customization target.

9. The method of controlling the information processing apparatus, according to claim 8,
wherein, the displaying does not display a printing setting in which the model received by the second reception unit is not supported, on the first screen.

10. The method of controlling the information processing apparatus, according to claim 8,
wherein the displaying displays information indicating whether the printing setting supported by the model received by the second reception unit is a printing setting supported by all the models or a printing setting supported by some of the models, on the second screen.

11. The method of controlling the information processing apparatus, according to claim 10,
wherein, if a cursor is combined with the model displayed on the second screen, the displaying displays a tooltip indicating the printing setting supported by the model.

12. The method of controlling the information processing apparatus, according to claim 8, further comprising:
storing the generated customization information in the printer driver set,
wherein the storing acquires device information of the printing device and stores the acquired device information and the generated customization information.

13. The method of controlling the information processing apparatus according to claim 12,
wherein, if the printing setting is not reflectable to the device information, the storing does not store the generated customization information.

14. The method of controlling the information processing apparatus according to claim 8,
wherein the displaying decides a display procedure of items of the printing setting displayed on the second screen based on a weight coefficient of a frequency of the customization and the number of supports.

15. A non-transitory storage medium on which is stored a computer program for making a computer execute a method for controlling an information processing apparatus, the method comprising:
receiving selection of a printer driver set including a plurality of printer drivers corresponding to models of a plurality of printing devices;
receiving selection of a model of a customization target from the printer driver set;
displaying a screen for customizing printing setting of the printer drivers; and
generating customization information based on the customized printing setting received via the screen,
wherein the displaying is configured to be able to display a first screen for collectively customizing a specific printing setting in a plurality of selected models of the customization target and a second screen for individually customizing a printing setting in one selected model of the customization target.
